(19) United States
(12) Patent Application Publication
(10) Pub. No.: US 2016/0162840 A1
(43) Pub. Date: Jun. 9, 2016

(54) TALENT ACQUISITION AND MANAGEMENT SYSTEM AND METHOD

(71) Applicants: Rick Roberts, The Woodlands, TX (US); Mike Roberts, Levelland, TX (US); Andrew Kaminsky, Houston, TX (US); April Patrick, New York, NY (US)

(72) Inventors: Rick Roberts, The Woodlands, TX (US); Mike Roberts, Levelland, TX (US); Andrew Kaminsky, Houston, TX (US); April Patrick, New York, NY (US)

(21) Appl. No.: 14/877,745

(22) Filed: Oct. 7, 2015

Related U.S. Application Data
(60) Provisional application No. 62/060,987, filed on Oct. 7, 2014.

(51) Int. Cl. G06Q 10/10

(52) U.S. Cl. CPC G06Q 10/1053

(57) ABSTRACT

A system and method for assigning and/or managing staffing needs. A software application may provide one or more portals or hubs that allow job requisitions to be created with particular user-defined requirements. A search is conducted, using both internal data and/or external data in order to find appropriate individuals to satisfy those job requisitions. The system and method may operate in conjunction with Managed Service Providers and Vendor Management Systems. Social features may be incorporated to aid in maintaining active user presence with the system and/or to promote targeted marketing and/or efficient referral systems. Referrals may take place by candidates themselves (e.g., referring another candidate) and/or by clients for different clients. Candidate curation methods may be included such that candidate mobility among different contracting jobs is more efficient and/or with less downtime between jobs.

### CROSS REFERENCE TO RELATED APPLICATIONS

This application claims the benefit of U.S. Provisional Patent Application Ser. No. 62/060,987, filed on Oct. 7, 2014, entitled “TALENT ACQUISITION AND MANAGEMENT SYSTEM AND METHOD,” which is hereby incorporated by reference in its entirety.

### BACKGROUND

1. Field

The present invention relates generally to a system and method for resource management. More particularly, the present invention relates to a computer system or method that is configured to manage a process of delivering resource information matched to client requirements.

2. Description of the Related Art

For many years, clients (e.g., businesses) have utilized outside firms in the staffing industry to aid them in their staffing needs. Such firms may provide these businesses with potential employees that can be hired on a temporary or a permanent basis. Over the past decade, the staffing industry has become highly commoditized, with little significant difference between the players. Drawing from a common pool of candidates, the conventional staffing industry is laden with process inefficiencies. For example, even though revenue in 2014 exceeded $2B, an average position took as many as 45 days to fill using conventional staffing methods, with only 10% of submittals from businesses resulting in a placement or hiring of an employee.

There has been some attempt by “Vendor Management Systems” (hereinafter termed “VMS”) and “Managed Service Provider” systems (hereinafter termed “MSP”) to provide a level playing field and to control price. Conventionally, a VMS provides filtered resource information to the MSP, which then manages distribution to various staffing and recruitment firms. This has caused increased focus on price over speed and quality by placing a barrier in between vendors and hiring managers. As a result, using conventional processes, hiring managers are often bombarded with resumes, who, although cognoscente of speed and quality, are led into a discussion of the price due to the relationship between the client and VMS/MSP. As a consequence, reducing costs by controlling vendor pricing has caused all vendors to behave in similar ways, leading to little, if any, incentive to build a long-term business relationship. Many undesirable side effects for the client result from such an arrangement, including, for example, increased time to hire, lower quality hires, and/or procedural inefficiencies that end up costing the client more than the arrangement helps to save.

The resource needs of any particular client can be as varied as the types of clients that are in need of resources at any one time. Moreover, any given client we will be dealing with many different jobs making it more difficult to proactively pipeline and use only marketing to identify, attract, and staff any particular resource need. The current practices involving resource management by VMS and MSP systems have become so engrained, that potential solutions may initially need to integrate with these systems (including VMS, MSP's and/or other vendors) in order to provide an online tool to help drive efficiencies, increase quality and/or bring relationships back to the staffing process. Some online solutions include staffing solutions focused on internal use at enterprise clients with lower skilled, hourly and seasonal workers in mind. For example, some companies use a combination of marketing and email campaigns to fill seasonal labor at high volumes during the holiday periods. However, these tools have traditionally not been customized or equipped with the necessary visualization processes or role and permission management protocols to enable them to offer an internal and/or external focus, nor are they sufficiently leveraged or resourced to manage an entire contingent workforce of one or a multiple clients. Thus, a need for improved staffing systems and/or methods to address one or more of the problems associated with conventional staffing processes is desired.

### SUMMARY

Some embodiments of the invention provide a talent acquisition and management system comprising at least one processor, and a first non-transitory computer-readable storage medium for tangibly storing thereon computer-readable instructions which when executed by the processor, cause at least a portion of a resource acquisition and management system to perform a series of steps of a method. The steps can include receiving and storing on a non-transitory computer-readable storage medium resource requirement information from a first computer system associated with at least one client, where the resource requirement information comprises at least a portion a workforce requirement. The steps include using the at least one processor to process at least a portion of the resource requirement information into a job flow comprising one or more job requirements. The steps also include establishing a link with at least one vendor, where the at least one vendor is coupled to at least one source of potential candidate information. Further, the steps include using the at least one processor to communicate the job flow to the at least one vendor, and receiving from the at least one vendor potential candidate information. The steps also include using the at least one processor to screen and rank at least a portion of the potential candidate information using at least one phase of a talent acquisition process. The talent acquisition process is configured to identify at least a partial match of a candidate from the potential candidate information based at least in part on the resource requirement information. The steps also include using the at least one processor to communicate screened candidate information based on a result from the talent acquisition process, where the result comprises candidate information that is at least partially matched to the at least one resource requirement information.

In one embodiment, a system for aiding in fulfilling staffing requests may include a processor and a memory for tangibly storing thereon computer-readable instructions configured to be executed by the processor. The computer-readable instructions may be configured to receive data from a client corresponding to a staffing requirement, establish a first link with a vendor for communication of at least some of the data received from the client, receive a plurality of candidate information corresponding to a plurality of candidates from the vendor for fulfilling the staffing requirement, analyze the plurality of candidate information from the vendor, rank at least some of the plurality of candidates based on the analysis of the plurality of candidate information received from the vendor, establish a second link with the client for communication of at least some of the plurality of candidate information received from the vendor and the rank of at least some of the plurality of candidates, and receive an approval from the client corresponding to at least one of the plurality of candidates.

In another embodiment, a method for aiding in fulfilling staffing requests may include receiving data from a client corresponding to a staffing requirement, establishing a first link with a vendor for communication of at least some of the data received from the client, receiving a plurality of candidate information corresponding to a plurality of candidates from the vendor for fulfilling the staffing requirement, analyzing the plurality of candidate information from the vendor, ranking at least some of the plurality of candidates based on the analysis of the plurality of candidate information received from the vendor, establish a second link with the client for communication of at least some of the plurality of candidate information received from the vendor and the rank of at least some of the plurality of candidates, and receiving an approval from the client corresponding to at least one of the plurality of candidates.

In still another embodiment, a system for aiding in fulfilling staffing requests may include a processor and a memory for tangibly storing thereon computer-readable instructions configured to be executed by the processor. The computer-readable instructions may be configured to receive data from a client corresponding to a staffing desire, establish a first link with a vendor for communication of at least some of the data received from the client, determine a plurality of candidate information corresponding to a plurality of candidates for fulfilling the staffing desire wherein at least some of the plurality of candidate information is determined via a plurality of candidate profiles editable by their corresponding plurality of candidates, rank at least some of the plurality of candidates based on at least some of the plurality of candidate information, and establish a second link with the client for communication of at least some of the plurality of candidate information received from the vendor and the rank of at least some of the plurality of candidates.

### BRIEF DESCRIPTION OF THE DRAWINGS

Other systems, methods, features, and advantages of the present invention will be or will become apparent to one with skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views, wherein:

FIG. 1A illustrates a resource acquisition and management architecture according to an embodiment of the invention;

FIG. 1B illustrates a resource acquisition and management architecture according to an embodiment of the invention;

FIG. 2 illustrates a resource acquisition and management process according to an embodiment of the invention;

FIG. 3 illustrates a representation of a vendor information flow used to perform at least one embodiment of the method accordance with at least one embodiment of the invention;

FIG. 4 illustrates a representation of a vendor information flow used to perform at least one embodiment of the method accordance with at least one embodiment of the invention;

FIG. 5 illustrates one example of a computer system that can be used to perform at least one embodiment of the method accordance with at least one embodiment of the invention;

FIG. 6A depicts a resource acquisition process in accordance with some embodiments of the invention;

FIG. 6B-1 depicts a resource acquisition process in accordance with some embodiments of the invention;

FIG. 6B-2 depicts the resource acquisition process in accordance with some embodiments of the invention;

FIG. 7 depicts a third phase of the resource acquisition process of FIG. 6A in accordance with some embodiments of the invention;

FIG. 8 depicts a fourth phase of the resource acquisition process of FIG. 6A in accordance with some embodiments of the invention;

FIG. 9 depicts a fifth phase of the resource acquisition process of FIG. 6A in accordance with some embodiments of the invention;

FIG. 10 depicts a sixth phase of the resource acquisition process of FIG. 6A in accordance with some embodiments of the invention;

FIG. 11 depicts a seventh phase of the resource acquisition process of FIG. 6A in accordance with some embodiments of the invention;

FIG. 12A illustrates a candidate and position preference selection dashboard in accordance with some embodiments of the invention;

FIG. 12B illustrates a representation of a candidate and position preference dashboard in accordance with some embodiments of the invention;

FIG. 13A depicts candidate score and rating level system in accordance with some embodiments of the invention;

FIG. 13B illustrates a candidate score and rating profile in accordance with some embodiments of the invention;

FIG. 14 illustrates a candidate profile board in accordance with some embodiments of the invention;

FIG. 15A illustrates a candidate profile window in accordance with some embodiments of the invention;

FIG. 15B illustrates a candidate profile window in accordance with some embodiments of the invention;

FIG. 16 illustrates a candidate profile in accordance with some embodiments of the invention;

FIG. 17 illustrates a candidate search window in accordance with some embodiments of the invention;

FIG. 18 illustrates a candidate search results window in accordance with some embodiments of the invention; and

FIG. 19 illustrates talent cloud curation process or system in accordance with some embodiments of the invention.

### DETAILED DESCRIPTION

Before any embodiments of the invention are explained in detail, it is to be understood that the invention is not limited in its application to the details of construction and/or the arrangement of components set forth in the following descriptions or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The detailed description of exemplary embodiments herein makes reference to the accompanying drawings and pictures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Some embodiments of the invention include information related to client resource requirements, staffing, and candidate information flowing through a “Vendor Management System” (hereinafter termed “VMS”). In some embodiments of the invention, the VMS can comprise a web-based application or suit of applications (e.g., software-based for execution upon a mobile device, such as a smartphone, tablet, laptop, etc. and/or other apparatus capable of software execution) that can provide and manage services related to staffing. In certain embodiments, the VMS system can include automated and/or consolidated processes that might ordinarily be one or more series of manual procedures. For example, in some embodiments, the VMS can distribute resource requirements to recruiters, individual staffing consultants or consulting companies, and/or staffing companies, etc., with the aim of facilitating candidate identification and selection, the candidate interview process, and/or expediting various processes and procedures related to final candidate identification and hiring. This can include various types of staffing categories including, but not limited to, permanent staff, temporary staff, contingent labor, and/or contract staff (including internal and external contractors, freelancers, and the like). In some embodiments, the VMS can include procurement order distribution and communications, reporting, and billing management.

Some embodiments of the invention include information management data and/or services related to client resource requirements, staffing, and/or candidate information managed through a “Managed Service Provider” (hereinafter termed “MSP”). In some embodiments, the MSP can manage one or more processes related to client resource requirements. For example, in some embodiments, the MSP can manage one or more recruiting vendors (hereafter called “vendors”). In this instance, the MSP can manage vendor selection, and/or monitor performance of a vendor (e.g., gauge the effectiveness of the vendor's candidate selection and matching to the resource requirements of any specific client). In some embodiments, the MSP can be directly accessed and coordinated by the client.

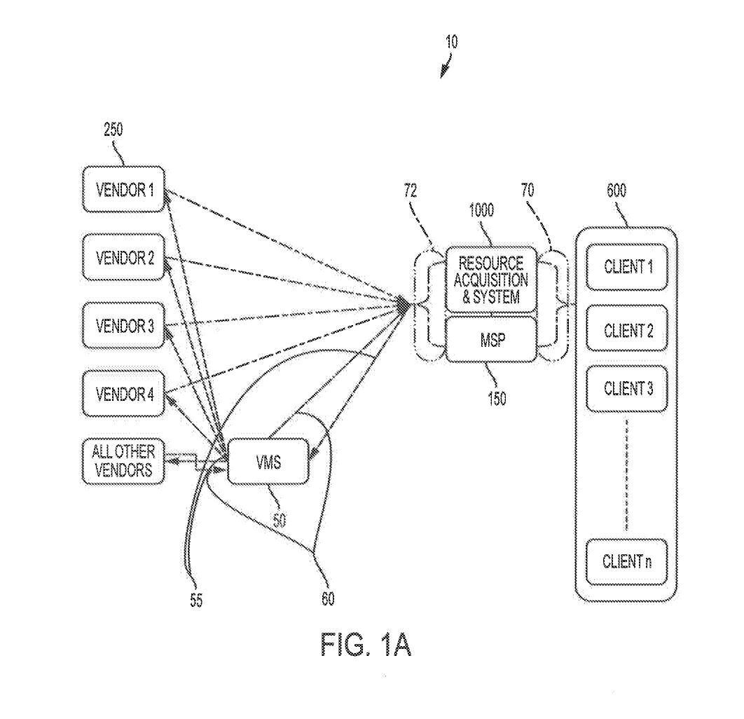

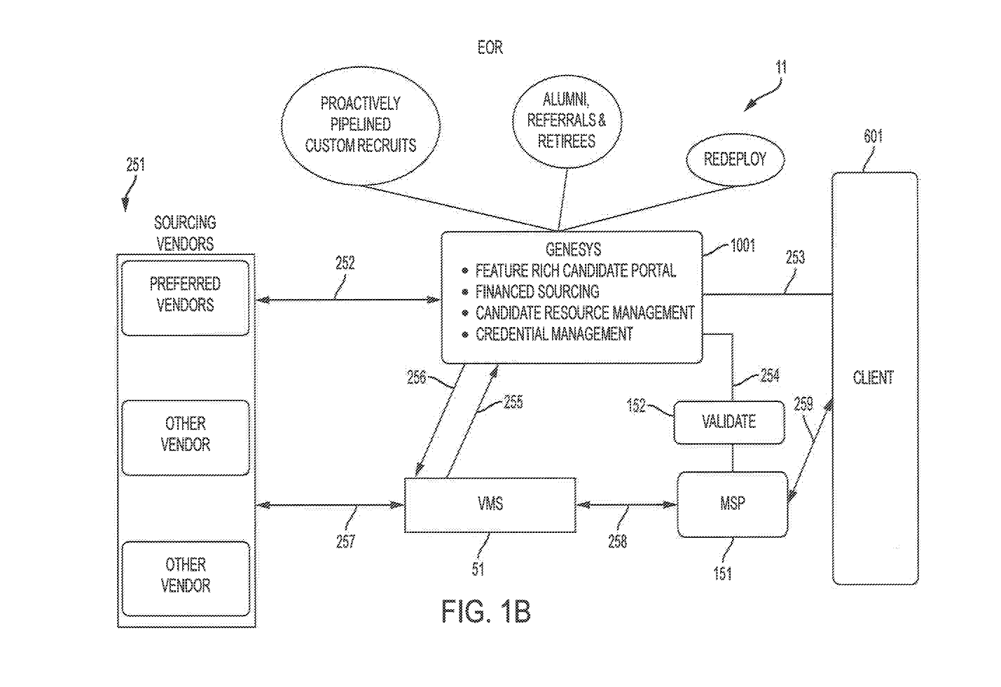

Some embodiments of the invention include a resource acquisition and management system 1000 that can be accessed and/or used by one or more clients seeking to match their resource requirements with staffing talent. As discussed throughout, staffing talent may be candidates that are entered into the system 1000 from a variety of different sources, for example, recruiters, recruitment process outsourcing, VMS, MSP, etc. FIG. 1A illustrates a resource acquisition and management architecture 10. In some embodiments of the invention, a resource acquisition and management system 1000 can be configured to communicate or interface with a VSM and/or an MSP to provide resource procurement services at least partially matched to client requirements. For example, in some embodiments, the resource acquisition and management system 1000 can communicate with a VMS 50, and an MSP 150 in various ways to provide resource and management services to one or more clients. In some embodiments, the resource acquisition and management system 1000 can establish and/or maintain one or more client relationships. Further, in some embodiments, the resource acquisition and management system 1000 can establish and/or maintain one or more vendor relationships.

In the context of one or more of the embodiments described herein, a vendor can include any entity, method, or process that can provide information related to a resource requirement. In some embodiments, the one or more vendors (e.g., shown as vendors 250 in FIG. 1) can couple to the resource acquisition and management system 1000 and/or the VMS 50. For example, such coupling may be communication over a private or public network (e.g., the Internet) via a web-based form or other software application. In the context of one or more embodiments of the invention, one or more of the vendors 250 can include online staffing and talent acquisition companies, employment pre-screening and selection companies, applicant tracking and checking systems, automated talent selection engines and databases, and the like. For example, in some embodiments, one or more of the vendors can comprise companies such as Findly.com (114 Sansome Street, 4th Floor San Francisco, Calif. 94104), JobDiva® (JobDiva, Inc., 44 Wall Street, 18th floor, New York, N.Y. 10005), and/or Chequed.com (513 Broadway, Saratoga Springs, N.Y. 12866. In some embodiments of the invention, the resource acquisition and management system 1000 can establish at least one vendor relationship. In some embodiments, the vendor relationship can comprise establishing one or more proprietary links between one or more vendors 250 (e.g., including forming electronic links with vendor computer systems comprising vendor data) for the purpose of exchanging information related to resource requirements.

In some further embodiments of the invention, the resource acquisition and management system 1000 can establish a client relationship that can include establishing one or more proprietary links between one or more clients 600 (e.g., including client computer systems and/or databases) for the purpose of exchanging information related to resource requirements. As shown in FIG. 1A, in some embodiments, the resource acquisition and management system 1000 can establish one or more links (e.g., shown as direct portal 70) to one or more clients 600. Further, in some embodiments, the resource acquisition and management system 1000 can also establish one or more links (e.g., shown as direct portal 72, which may be the same as or similar to portal 70) between one or more of the vendors 250 and one or more of the clients 600 managed through the resource acquisition and management system 1000. In this fashion, in some embodiments, a job flow 55 can flow from the resource acquisition and management system 1000 and through and/or from the VMS 50, to at least one of the vendors 250. Further, in some embodiments, at least one of the vendors 250 can provide a candidate flow 60 to the resource acquisition and management system 1000 via the VMS 50.

One or more of the clients 600 can comprise a single client or multiple clients (with client 1, client 2, client 3, up to “n” number of clients). In some embodiments, using one or more of the methods described herein, the resource acquisition and management system 1000 can analyze any client-provided information related to resource requirements. Using one or more information resources (including any information flowing from the vendors 250, VMS 50 and/or MSP 150), the resource acquisition and management system 1000 can prepare and deliver information (e.g., staffing resource information) related to one or more candidates directly or indirectly to one or more clients 600. Further, in some embodiments, the one or more information resources can comprise one or more internal databases. In some further embodiments, the one or more information resources can comprise one or more external databases and/or other data sources by coupling through at least one communication network such as an Internet network, an intranet network, and/or a local area network.

In some embodiments, one or more of the aforementioned services (e.g., comprising the delivery of staffing resource information related to a client resource requirement), can be accessed and/or tailored to a single client, or across multiple clients 600, either internally or externally from one or more of the clients 600. For example, in some embodiments the resource acquisition and management system 1000 can operate as a sole internal service for one or more clients. In this instance, the resource acquisition and management system 1000 may include systems dedicated to certain of the clients 600, but not shared with other of the clients 600. In some further embodiments, the resource acquisition and management system 1000 can function as an external service to one or more clients 600. In still other embodiments, the resource acquisition and management system 1000 may function as an external service to one or more clients 600 when combined with at least one internal client service.

In some embodiments, a client can opt to enable the MSP 150 to control flow of one or more staff resources to one or more of the clients 600. The MSP 150 may couple to the resource acquisition and management system 1000 to manage the workforce of one or more of the clients 600. Further, in some embodiments, the MSP 150 and/or the resource acquisition and management system 1000 can redeploy staff (such as current contractors), engage alumni, and/or retain custom recruited contractors. This can be useful, for example, when a commitment from prior and/or current staff has expired or is due to expire and the client wishes to extend the commitment for a further term or period of time.

In certain embodiments, the resource acquisition and management system 1000 can share at least one information resource between at least two of the clients 600. For example, resource information and/or other data (e.g., corresponding to one or more candidates related to a resource requirement from a first one of the clients 600) can be shared with one or more of the other clients 600. In one embodiment, the resource acquisition and management system 1000 can be coupled to a single vendor company that operates as a single staffing hub for providing staffing resources to the resource acquisition and management system 1000. In some other embodiments, one or more of the vendor systems can be used to track applications and/or can be used by one or more recruiters.

FIG. 1B shows another embodiment of a resource acquisition and management architecture 11. The resource acquisition and management architecture 11 may include features that are the same as or similar to those discussed throughout, for example, in FIG. 1A. The resource acquisition and management architecture 11 may include a system or portal 1001 that allows one or more clients 601 access thereto for the purposes of finding and hiring candidates (e.g., recruited individuals, alumni, retirees, prior individuals previously employed with the client) to find staffing placement) to fulfill desired positions.

The resource acquisition and management system 1001 may interface 252 with one or more sourcing vendors 251 (e.g., preferred vendors and/or other vendors) for supplying all or some of the candidates that may be available as potential staffing options for the one or more clients 601. Similar to previous discussions, the resource acquisition and management system 1001 may interface with a VMS 51 and/or MSP 151 to aid in controlling a flow of information to or from the one or more clients 601. For example, the VMS 51 may interface 257 with one or more of the sourcing vendors 251 and also interface 258 with the MSP 151. The VMS 51 may provide job feed information 255 to the resource acquisition and management system 1001 and also receive information 256 (e.g., regarding candidate priority information or data) from the resource acquisition and management system 1001. Likewise, the MSP 151 may interface 259 with one or more of the clients 601 in aiding in controlling the flow of information to or from the one or more clients 601 and may provide validation processes 152 regarding candidates for potential hire to 254 the resource acquisition and management system 1001. In certain embodiments, direct feedback 253 (e.g., from a hiring manager of one or more clients 601) may be permitted directly to the resource acquisition and management system 1001 without having to go through the MSP 151. Any of a variety of possible configurations may be setup in alternative embodiments that allow an MSP, VMS, vendor, and/or client to interface with a resource acquisition and management system and/or with each other for the purposes of providing improved staffing solutions.

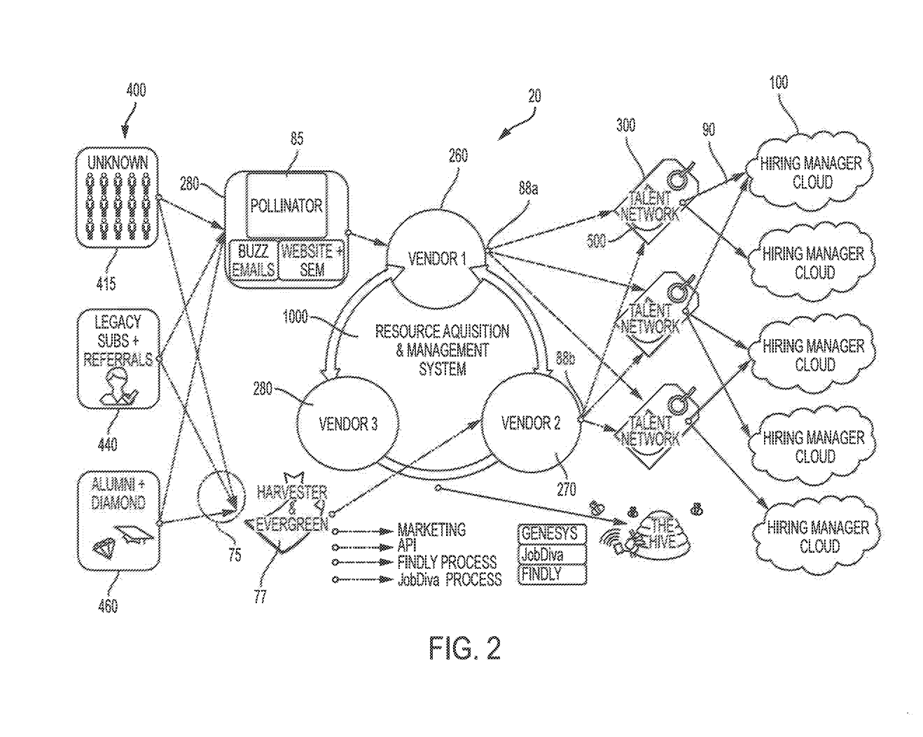

The resource acquisition and management system 1000 and/or system 1001, operating within at least one embodiment of the resource acquisition and management architecture 10 described above and shown in FIG. IA, can dynamically link staffing resources from one or from a plurality of sources, process those staff resources to form a network of staffing resources, filter and process pools of ideal candidates, and/or communicate the staffing resources including any ideal candidates to one or more hiring manager clouds (accessible by hiring managers from one or more clients 600). FIG. 2 illustrates one example of a resource acquisition and management process 20 that is configured to deliver a network of staffing resources to one or more clients (e.g., the same or similar to the clients 600 discussed for FIG. 1A).

As shown, the resource acquisition and management system 1000 and/or system 1001 can be operating coupled with or interfaceable by more or more vendors 250 (e.g., such as first vendor 260, a second vendor 270, and/or a third vendor 280). The resource acquisition and management system 1000 and/or system 1001 may be configured to exchange resource information (e.g., comprising potential staffing options such as potential candidates for an active client resource requirement). Potential candidates can comprise active and/or passive job seekers that can enter at least one process of the resource acquisition and management architecture 10 in response to a marketing channel. For example, in some embodiments, a candidate flow 75 comprising staff resources 400 comprising unknown candidates 415, legacy and/or sub-referrals 440, and/or alumina and diamond rated candidates 460 (e.g., rating level discussed in greater detail herein) can flow to the resource acquisition and management system 1000 and/or system 1001 through a vendor (such as the second vendor 270 as shown) following a marketing process 77.

In some further embodiments, a candidate flow 80 can flow to the resource acquisition and management architecture 10 following a “one click process” 85. In such an embodiment, the candidate flow 80 can flow into the resource acquisition and management system 1000 and/or system 1001 through at least one vendor (such as the first vendor 260 as shown). The “one click process” 85 can comprise an alert and/or information and/or notifications sent by the job seeker (e.g., the candidate) through any of a variety of communication means, such as email, an online link, an instant message, etc.

The resource acquisition and management system 1000 and/or system 1001 can analyze and process one or more of the candidates (e.g., those entering the resource acquisition and management architecture 10 through candidate flows 75, 80) to form a network of staffing resources. These resources can flow as a matched or partially matched candidate flow 88a, 88b to one or more talent networks 300. The resource acquisition and management system 1000 and/or system 1001 can analyze, filter, and/or process pools of ideal candidates to form at least one hot list 500. In some further embodiments, the one or more talent networks 300 and/or the one or more hot lists 500 can comprise a candidate flow 90 to a hiring cloud. In this instance, one or more hiring manager clouds 100 (accessible by hiring managers from the one or more clients 600) can receive at least one ideal candidate via the resource acquisition and management system 1000 and/or system 1001.

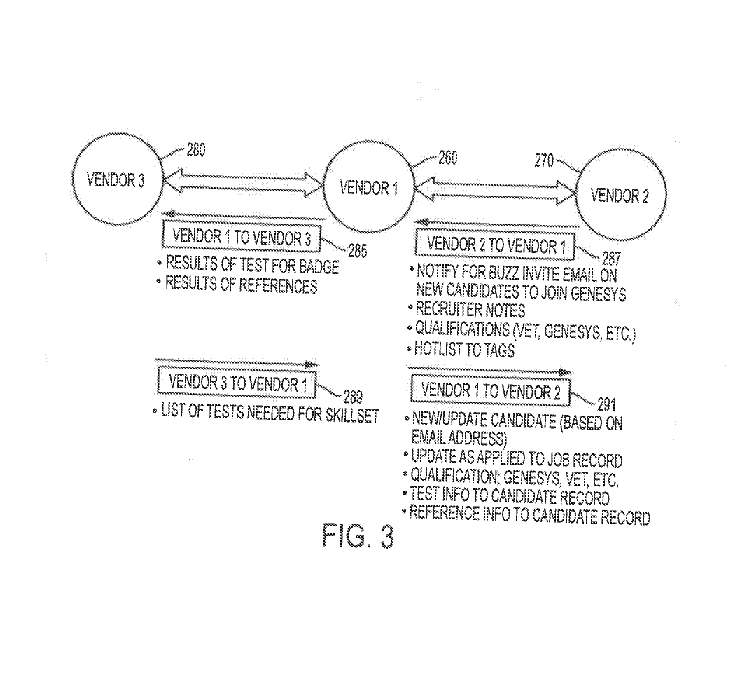

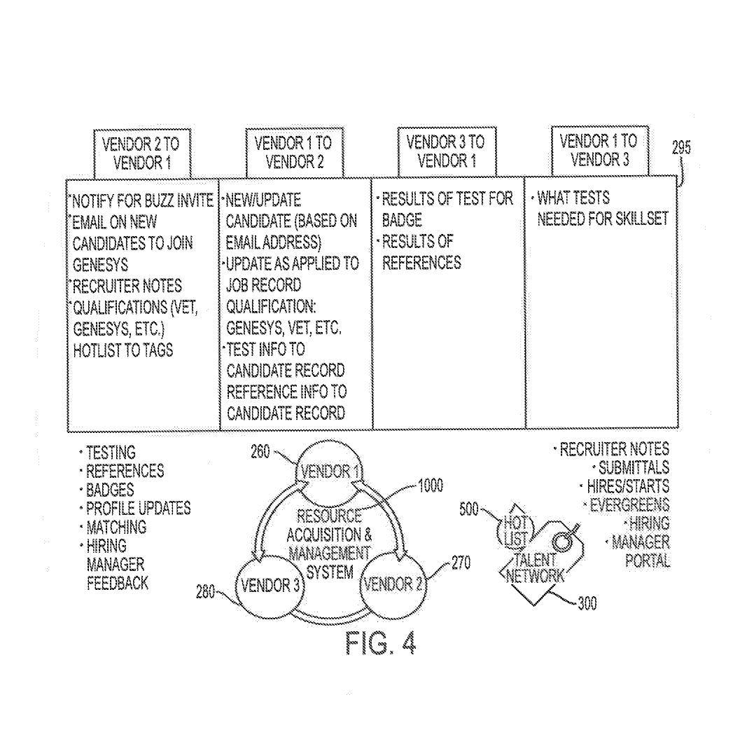

As previously mentioned, some embodiments of the invention may include exchange of candidate information between one or more vendors (e.g., vendors 250). For example, FIGS. 3 and 4 illustrate a representation of a vendor information flow used to perform at least one embodiment of the invention. Candidate information can flow between any of a variety of vendors (e.g., vendors 250, such as vendors 260, 270, and/or 280) when operating within the resource acquisition and management process 20. For example, as shown in FIG. 4, vendor communication 295 can comprises the exchange of candidate information between one or more vendors (e.g., vendors 250, such as vendors 260, 270, and/or 280). This information exchange can operate as a component of any of the methods of the resource acquisition and management system 1000 and/or system 1001 when compiling at least one talent network 300 and/or hot list 500 (for example, as illustrated in FIGS. 2 and/or 4). With reference to FIGS. 4 and 3, the vendor communication 295 can comprise candidate information flowing between the first vendor 260 and the third vendor 280 (shown as flow 285). Additionally, candidate information can flow between the second vendor 270 and the first vendor 260 (shown as flow 287). Likewise, candidate information can flow between the third vendor 280 and the first vendor 260 (shown as flow 289). Moreover, candidate information can flow between the first vendor 260 and the second vendor 270 (shown as flow 291). Indeed, alternative embodiments may allow vendor communication between any, all, or only some of various vendors that are capable of communicating and/or interfacing with a resource acquisition and management system (e.g., the resource acquisition and management system 1000 and/or system 1001).

For the exemplary embodiment shown in FIG. 3, the flow 285 can include data and/or results relating to a test for badge and/or data and/or results relating to one or more references. The flow 287 can include a notification for a communication (such as an email), for example, a “buzz” or other audible/visual/tactile indication) relating to new candidates that join the resource acquisition and management system 1000 and/or system 1001, recruiter notes, candidate qualifications, and/or hotlist to tags. The flow 289 can include lists of tests needed for the skillset. Further, the flow 291 can include information on a new and/or updates to a candidate (e.g., based on an email address), updates as applied to the job board, qualifications, test information to a candidate record, and/or reference information to a candidate record. Although described and shown with exemplary communications and/or data flow, in alternative embodiments, any of a variety of information and/or data may be configured to flow between one or more vendors.

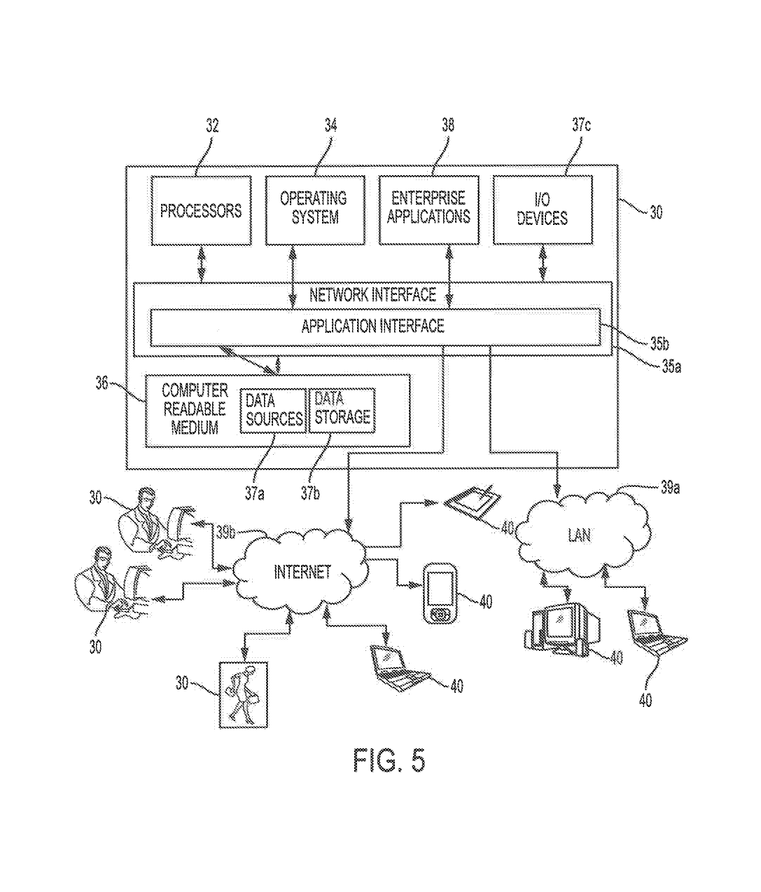

The resource acquisition and management system (e.g., the resource acquisition and management system 1000 and/or system 1001) can utilize a computer system to operate and/or process resource related information within a resource acquisition and management architecture (e.g., the resource acquisition and management architecture 10). FIG. 5 illustrates one example of a system 30 that can be used by one or more software modules of the resource acquisition and management system 1000 and/or system 1001 to perform one or more processes related to delivering resource information that is at least partially matched to client requirements. For example, the resource acquisition and management system 1000 and/or system 1001 can utilize the system 30 to operate to process resource related information to perform an embodiment of the resource acquisition and management process 20 within the resource acquisition and management architecture 10. In some embodiments, the system 30 can include at least one computing device, including at least one or more processors 32. In some embodiments, at least one or more of the processors 32 can include processors residing in one or more conventional server platforms.

In some embodiments, the system 30 can include a network interface 35a and an application interface 35b coupled to the at least one or more processors 32 and capable of running at least one operating system 34. Further, the system 30 can include a network interface 35a and an application interface 35b coupled to at least one or more processor 32 capable of running one or more of the software modules 38 (e.g., one or more enterprise applications). In some embodiments, the one or more software modules 38 can comprise a server-based software platform. In some embodiments, the system 30 can also include at least one computer readable medium 36. The at least one computer readable medium 36 can be coupled to at least one data storage device 37b, and/or at least one data source 37a, and/or at least one input/output device 37c.

The invention can also be embodied as computer readable code on a computer readable medium 36. The computer readable medium 36 can be any data storage device that can store data, which can thereafter be read by a computer system. Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. In some embodiments, the computer readable medium 36 can also be distributed over a conventional computer network. For example, in some embodiments, the computer readable medium 36 can also be distributed over and/or accessed via the network interface 35a. In this instance, computer readable code can be stored and executed in a distributed fashion using the computer system 30.

For example, in some embodiments, one or more components of the system 30 can be tethered to send and/or receive data through a local area network (“LAN”) 39a. In some further embodiments, one or more components of the system 30 can be tethered to send or receive data through an internet 39b (e.g., a wireless internet). In some embodiments, at least one software module 38 running on at least one processor 32 can be configured to be coupled for communication over a network 39a, 39b.

In some embodiments, one or more components of the network 39a, 39b can include one or more resources for data storage and retrieval. This can include any computer readable media in addition to the computer readable media 36, and can be used for facilitating the communication of information from one electronic device to another electronic device. Also, in some embodiments, the network 39a, 39b can include wide area networks (“WAN”), direct connections (e.g., through a universal serial bus port), other forms of computer-readable media 36, or any combination thereof. In some embodiments, the software modules 38 can be configured to send and receive data from a database (e.g., from a computer readable medium 36 including data sources 37a and data storage 37b that can comprise a database). Further, in some embodiments, data can be accessed and received by the software modules 38 from at least one other source.

In some embodiments, one or more components of the network 39a, 39b can include a number of client devices which can be personal computers or electronic devices (e.g., including desktop computers, laptop computers, digital assistants, personal digital assistants, cellular phones, mobile phones, smart phones, pagers, digital tablets, internet appliances, and other processor-based devices, etc.) that users 40 can interact with in order to engage with the system 30. In general, a client device can be any type of external or internal devices such as a mouse, a CD-ROM, DVD, a keyboard, a display, or other input or output devices 37c. In some embodiments, at least one of the software modules 38 can be configured within the system to output data to a user 40 via at least one digital display. Further, in some embodiments, various other forms of computer-readable media 36 can transmit or carry instructions to a user 40 that may include a router, private or public network, or other transmission device or channel, both wired and wireless.

In some embodiments, the system 30 as described can enable one or more users 40 to receive, analyze, input, modify, create and send data to and from the system architecture 30, including to and from one or more software modules 38 running on the system architecture 30. Some embodiments include at least one user 40 accessing one or more modules or architectures (e.g., the resource acquisition and management architecture 10) that include at least one software module 38 via a stationary I/O device 37c through a LAN 39a. In some other embodiments, the system 30 can enable at least one user 40 accessing software module 38 via a stationary or mobile I/O device 37c through the internet 39a. The users 40 may comprise one or more clients (e.g., clients 600 as previously discussed). In some embodiments, the users 40 can comprise the resource acquisition and management system 1000 and/or system 1001. In some other embodiments, the users 40 can comprise a system manager, an administrator, an internal hiring manager, and/or an external hiring manager.

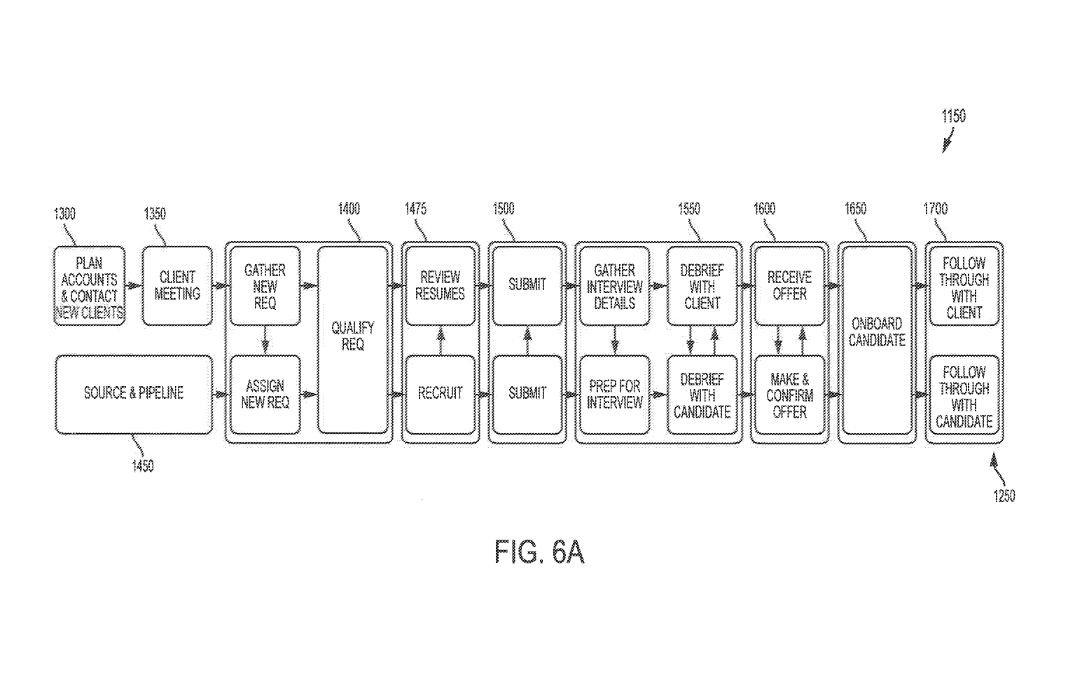

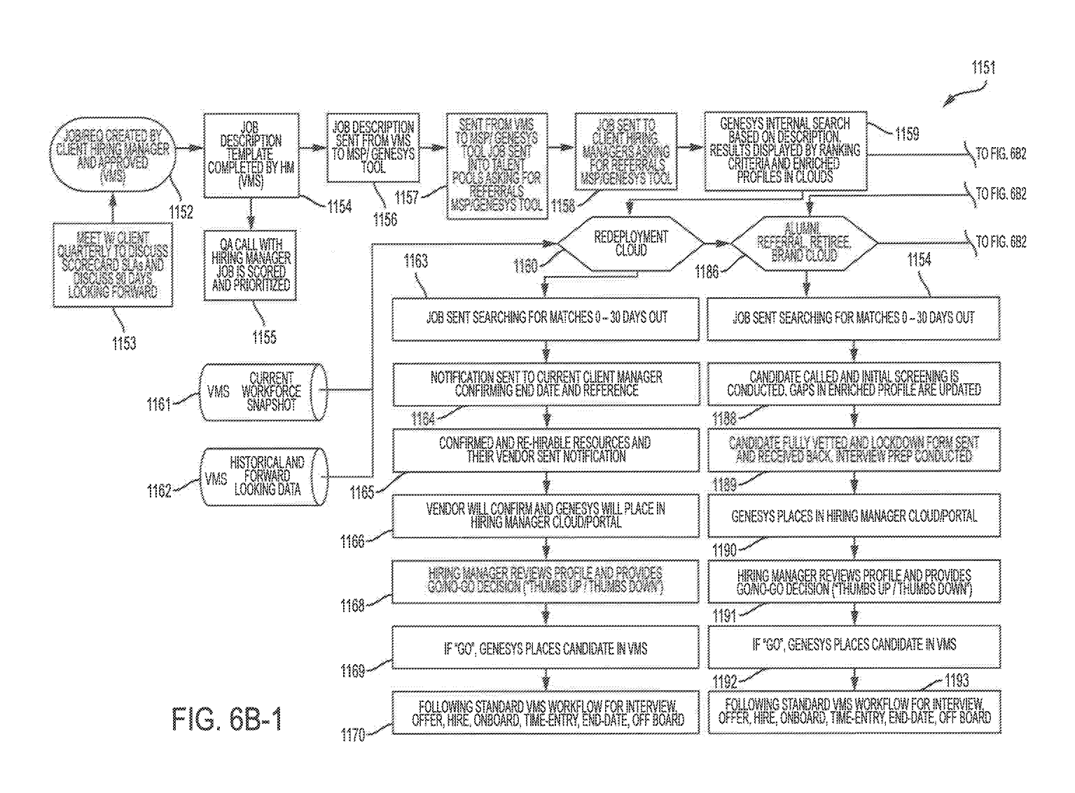

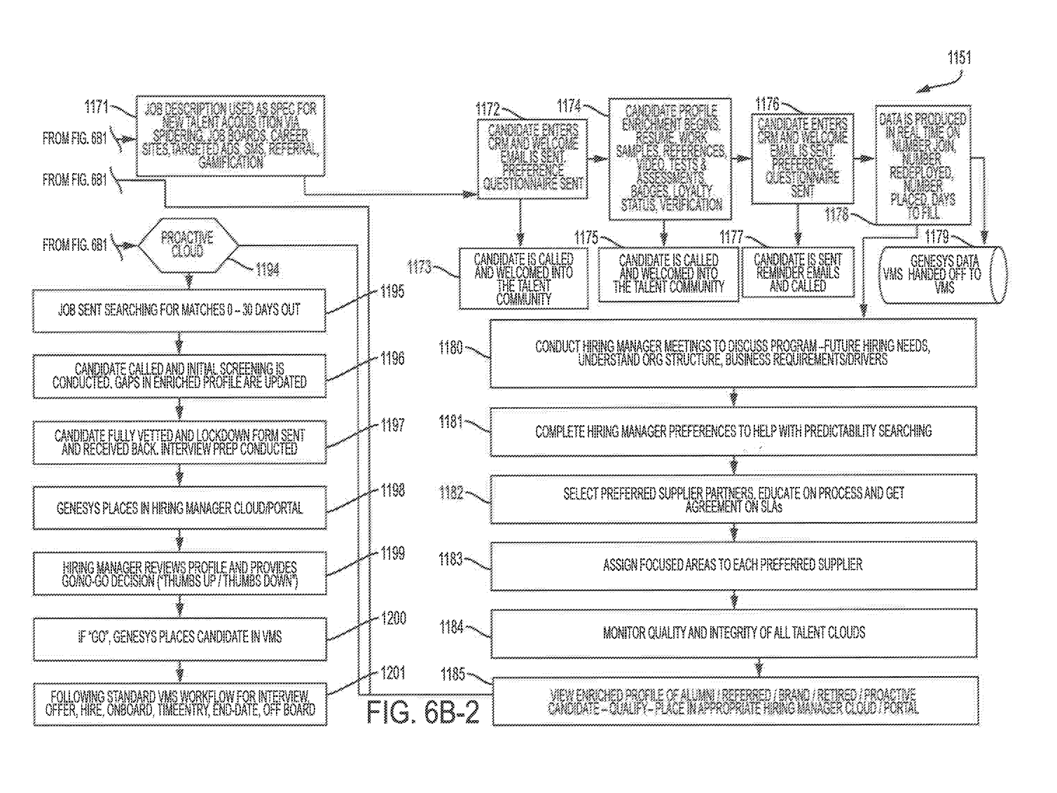

A resource acquisition and management system as discussed throughout (e.g., the resource acquisition and management system 1000 and/or system 1001) can include a resource acquisition process comprising a series of parallel and/or serial steps for identifying and acquiring talent for one or more clients (e.g., clients 600). This resource acquisition process can include processing candidate invitations and/or candidate registration (e.g., through a web interface configured by the resource acquisition and management system 1000 and/or system 1001). For example, FIG. 6A depicts a resource acquisition process 1150 in accordance with some embodiments of the invention. Likewise, FIGS. 6B-1 and 6B-2 depicts a resource acquisition process 1151 in accordance with some embodiments of the invention. Various process steps illustrated by FIGS. 6A and 6B-1 and 6B-2 may be re-arranged, deleted, or otherwise reconfigured with additional steps as desired in alternative embodiments.

In FIG. 6A, the resource acquisition process 1150 can comprise a plurality of phases 1250 including, but not limited to, a first phase 1300, a second phase 1350, a third phase 1400, a fourth phase 1450, a fifth phase 1475, a sixth phase 1500, a seventh phase 1550, an eighth phase 1600, an ninth phase 1650, and a tenth phase 1700. In some embodiments, the resource acquisition and management system 1000 and/or system 1001 can process any one of the phases 1250. In some embodiments, any of the phases 1300, 1350, 1400, 1450, 1475, 1500, 1550, 1600, 1650, and/or 1700 can be processed by the resource acquisition and management system 1000 and/or system 1001 serially or in parallel. For example, in some embodiments, each of the phases 1300, 1350, 1400, 1450, 1475, 1500, 1550, 1600, 1650, and/or 1700 can be processed by the resource acquisition and management system 1000 and/or system 1001 individually before proceeding to process another one of the phases 1250. Alternatively, any of the phases 1300, 1350, 1400, 1450, 1475, 1500, 1550, 1600, 1650, and/or 1700 can be processed by the resource acquisition and management system 1000 and/or system 1001 substantially simultaneously (e.g., in parallel) as at least one other of the phases 1250.

The resource acquisition process 1150 can include processing candidates into one or more specific skill areas, and screening candidates through a screening processed within the resource acquisition and management system 1000 and/or system 1001. The resource acquisition process 1150 can include processing a profile and candidate testing portal processed though the resource acquisition and management system 1000 and/or system 1001. Further, the resource acquisition and management system 1000 and/or system 1001 can process a profile and background review of a candidate, and prepare a predictor and score analysis using a certification process.

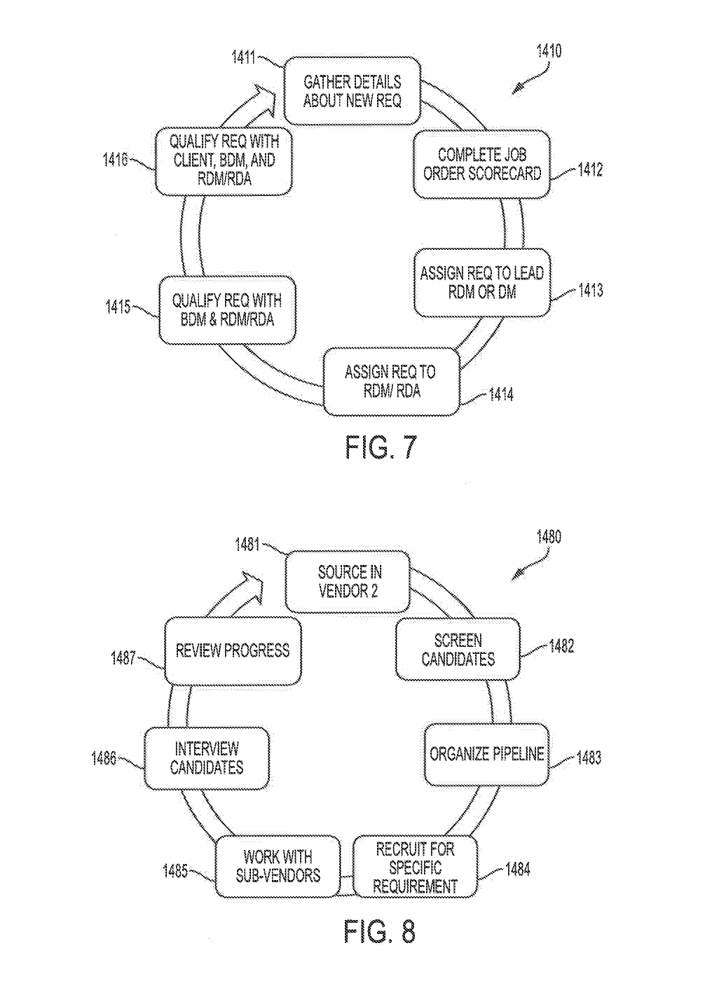

Referring to FIG. 6A, in some embodiments of a system, such as the resource acquisition and management system 1000 and/or system 1001 previously discussed, that is utilizing the resource acquisition process 1150, during a first phase 1300, the resource acquisition and management system 1000 and/or system 1001 can process and/or facilitate account planning and/or communicate with one or more new clients 600. During the second phase 1350, the resource acquisition and management system 1000 and/or system 1001 can process and facilitate one or more client meetings. A third phase 1400 occurs where the resource acquisition and management system 1000 and/or system 1001 facilitates gathering a new requisition, assigning a new requisition, and/or qualifies a requisition. A fourth phase 1450 occurs where the resource acquisition and management system 1000 and/or system 1001 can be used to source and pipeline process across any of the phases 1400, 1450, 1475, 1500, 1550, 1600, 1650, and/or 1700. During the fifth phase 1475, the resource acquisition and management system 1000 and/or system 1001 can include resume review and recruitment processes. During a sixth phase 1500, processes may operate that comprise submission of resumes and/or candidates information. The seventh phase 1550 can comprise gathering of interview details, interview preparation processes, and various candidate and client debriefing procedures. The eighth phase 1600 can comprise making and confirming an offer, and/or candidates receiving an offer. The ninth phase 1650 can comprise onboarding of a candidate. In some other embodiments, the tenth phase 1700 can comprise follow through with client, and/or follow through with candidate. Various of the above-described phases and/or steps or processes of one or more of the above-described phases are described in greater detail for exemplary embodiments in FIGS. 7-11.

Before turning to additional details or steps that may be incorporated in one or more phases illustrated in FIG. 6A, FIGS. 6B-1 and 6B-2 illustrates an alternative resource acquisition process 1151 that may be utilized in an alternative embodiment of a system (e.g., a resource requisition and management system 1000 and/or 1001 as previously discussed) for placing staff and that operates in conjunction with a VMS and MSP. As illustrated, a plurality of process steps are shown in FIGS. 6B-1 and 6B-2, certain of those steps being the same or similar as discussed throughout.

More specifically, and as illustrated, step 1152 includes a job or requisition created by a client hiring manager. This creation may be performed and/or approved via a VMS. Step 1153 includes meeting with a client (e.g., quarterly) in order to discuss certain requirements related to the job or requisition (e.g., scorecard criteria, as discussed in greater detail herein), etc. Step 1154 includes creation of a template based upon the job or requisition description from the client (e.g., via a VMS). Step 1155 includes quality assurance with the client hiring manager to ensure the job or requisition is appropriately described within the VMS. Step 1156 includes sending of the job description from the VMS to the system. Step 1157 includes the sending of the job or requisition into one or more talent pools that ask for referrals via the MSP and/or the system. At step 1158, the job or requisition is sent to the client hiring managers to ask for referrals via the MSP and/or the system.

At step 1159, the system performs a search (e.g., an internal search) based upon the job description. Results of appropriate candidates are then displayed and/or transmitted to the client for review as potential staff. As a part of this search, various locations (e.g., “clouds”) may be examined for candidates. A “redeployment” cloud 1160 may be looked to for providing candidates that are already employed at the client (e.g., a current workforce snapshot 1161), or were previously deployed at that client or to be deployed at the client (e.g., a historical and forward looking snapshot 1162), and thus may be acceptable candidates for the currently pending job request.

A series of substeps may be taken for a potential candidate to be chosen for staffing placement based upon a candidate being within the redeployment cloud 1160. For example, step 1163 includes searching for candidate matches that are 0-30 days out from the current job request beginning. Step 1164 sends a notification to the current client manager confirming the end date of the candidate and asking for reference feedback. Step 1165 includes confirming re-hirable resources and sending the vendor of the candidate a notification. Step 1166 includes confirmation from the vendor and subsequent placement of the specific candidate within the hiring manager cloud/portal. Step 1168 includes review by the hiring manager and deciding whether to include the candidate within the redeployment cloud 1160 or not. If the decision is made to include the candidate, step 1169 places the candidate in the VMS. At step 1170, the standard VMS workflow for candidate interview, offer, hire, onboard, time-entry, end-date, and/or offboard is followed for the staffing placement of the candidate.

An “alumni referral, retiree, brand” cloud 1186 may also be looked to for searching for candidates thus may be acceptable for the currently pending job request. Similar to the above, a series of substeps may be taken for a potential candidate to be chosen for staffing placement based upon a candidate being within the “alumni referral, retiree, brand” cloud 1186. For example, step 1187 includes searching for candidate matches that are 0-30 days out from the current job request beginning. Step 1188 includes calling in and initial screening of the candidate and filling in of information or profile gaps associated with the candidate. Step 1189 includes vetting the candidate, scheduling and confirming interest and availability for interviewing between the candidate and the client, and prepping the candidate for the interview. Step 1190 includes subsequent placement of the specific candidate within the hiring manager cloud/portal. Step 1191 includes review by the hiring manager and deciding whether to include the candidate within the “alumni, referral, retiree, brand” cloud 1186 or not. If the decision is made to include the candidate, step 1192 places the candidate in the VMS. At step 1193, the standard VMS workflow for candidate interview, offer, hire, onboard, time-entry, end-date, and/or offboard is followed for the staffing placement of the candidate.

A “proactive” cloud 1194 may also be looked to for searching for candidates that may be acceptable for the currently pending job request. Similar to the above, a series of substeps may be taken for a potential candidate to be chosen for staffing placement based upon a candidate being within the “proactive” cloud 1194. For example, step 1195 includes searching for candidate matches that are 0-30 days out from the current job request beginning. Step 1196 includes calling in and initial screening of the candidate and filling in of information or profile gaps associated with the candidate. Step 1197 includes vetting the candidate, scheduling and confirming interest and availability for interviewing between the candidate and the client, and prepping the candidate for the interview. Step 1198 includes subsequent placement of the specific candidate within the hiring manager cloud / portal. Step 1199 includes review by the hiring manager and deciding whether to include the candidate within the “proactive” cloud 1194 or not. If the decision is made to include the candidate, step 1200 places the candidate in the VMS. At step 1201, the standard VMS workflow for candidate interview, offer, hire, onboard, time-entry, end-date, and/or offboard is followed for the staffing placement of the candidate.

Step 1171 includes the use of the job description provided to the system for locating of potential candidates from external sources (e.g., client recruitment firms, job boards, career sites, targeted ads, messaging such as text or email, other referral sources, gamification, etc.). Upon the locating of a potential candidate using one of these external sources, this potential candidate begins engaging with the system via a social connector (e.g., custom URLs can be used that tag candidates for easy segmentation through relevant metadata) or social layer of the system, as described in greater detail herein. At step 1172, the candidate enters the system and a welcome email is sent along with a preference questionnaire in order to begin building their profile. At step 1173, the client is called and welcomed into the talent community. Step 1174 includes enrichment of the candidates profile, for example, by creating, updating, and/or uploading (either by the candidate and/or by the system itself) a resume, work samples, references, videos, tests or assignments, badges, loyalty status, verification, etc. Similar to step 1173, subsequent to the enrichment of the candidate profile, the candidate may again be called and welcomed into the same and/or different talent communities based upon their profile information.

Similar to step 1172, at step 1176, the candidate enters the system and a welcome email is sent along with a preference questionnaire. Step 1177 includes sending the candidate reminder emails and/or calls. At step 1178, data is produced (e.g., in real time) concerning a variety of information related to the candidate, such as number of placements, number of times redeployed with the same client, etc. Step 1180 includes conducting hiring manager meetings to discuss hiring needs, understanding the client's organizational structure, business requirements, drivers, etc. Step 1181 includes completing and/or inputting the hiring manager's needs in order to aid with predictability in searching. Step 1182 includes selecting of preferred supplier partners and/or educating them on the processes to be filed as part of the system. Step 1183 includes assigning focus areas to each preferred supplier and step 1184 includes monitoring the quality and integrity of the talent clouds previously discussed. Step 1185 includes viewing of the various candidate profiles that are located in one or more of the talent clouds and placing appropriate candidate profiles in hiring manager cloud/portal for their perusal to satisfy staffing needs.

Turning to FIG. 7 depicting a process phase 1410 (e.g., the same or similar to the third process phase 1400 of FIG. 6A), the resource acquisition and management system 1000 and/or system 1001 can process and/or facilitate information flow relating to requisition of candidates for potential staffing. Step 1411 includes gathering details about a new requisition. This may be requirements desired by a company relating to either a potential candidate and/or the job or task for which the requisition relates. Step 1412 includes completing a job order scorecard, as discussed in greater detail herein. Step 1413 includes assigning a requisition to a lead resource development manager and/or development manager. Step 1414 includes assigning a requisition to a resource development manager and/or resource development associate. In certain embodiments, the resource development manager and/or resource development associate may be the same individual as the lead resource development manager and/or development manager of Step 1413. Step 1415 includes initially processing and/or facilitating qualification of a requisition with a business development manager, and/or a resource development manager, and/or resource development associate. At step 1416, after the initial processing and/or facilitating of qualification (e.g., internally without client involvement), the client may be involved to facilitate final qualification of a requisition with the client and/or a business development manager, and/or a resource development manager, and/or resource development associate.

FIG. 8 depicts a process phase 1480 (e.g., the same or similar to the fifth process phase 1475 of FIG. 6A), the resource acquisition and management system 1000 and/or system 1001 can process and/or facilitate information flow relating to recruitment of candidates for potential staffing. As illustrated, step 1481 includes processing and/or facilitating information flow by sourcing candidates from at least one vendor (e.g., the second vendor 270 in an example embodiment with reference to previous discussions). Step 1482 includes processing a screen of one or more candidates according to various criteria as desired (e.g., background checks, education, work experience, etc.) Step 1483 includes organizing a candidate pipeline (e.g., determining a list of potential candidates for further recruitment steps, prioritizing specific candidates over others, determining a schedule for continued recruitment steps of one or more candidates, etc.). Step 1484 includes recruiting candidates according to specific requirements (e.g., requirements obtained from one or more interested clients). Step 1485 includes working with sub-vendors in order to obtain additional information about particular candidates and/or obtaining new candidates for potential recruitment. Step 1486 includes interviewing of one or more candidates for recruitment (e.g., in-person interviews, telephone interviews, etc.). Step 1487 may be an internal process that includes reviewing progress with one or more candidates for recruitment in order to determine next steps in either continuing such recruitment and/or dropping a particular candidate as one desired for recruitment.

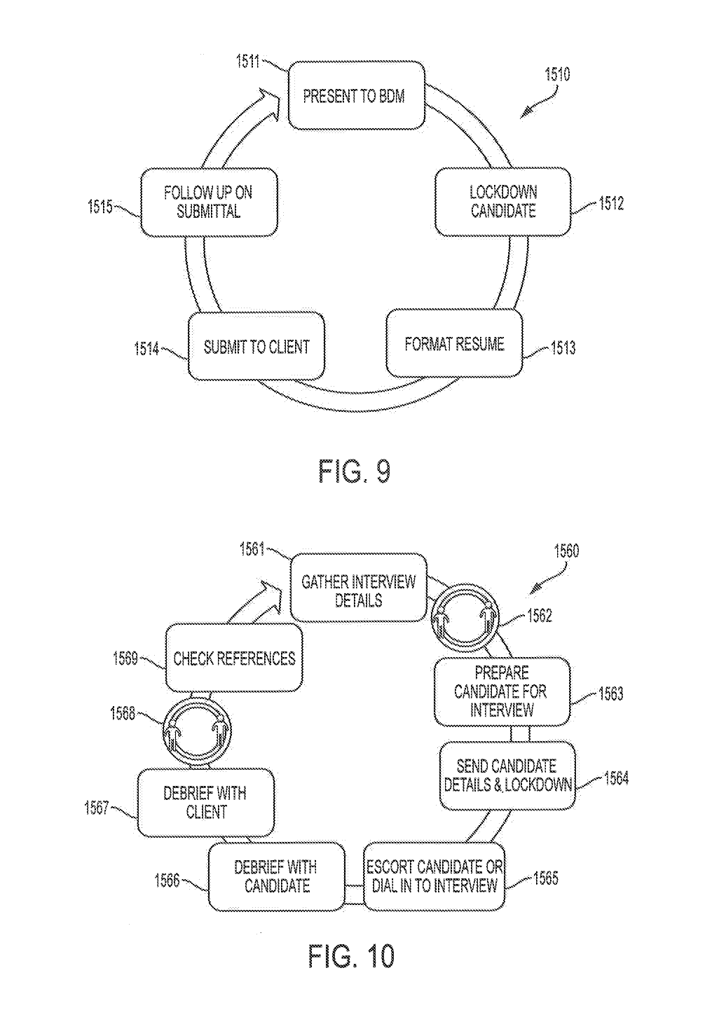

FIG. 9 depicts a process phase 1510 (e.g., the same or similar to the sixth process phase 1500 of FIG. 6A), the resource acquisition and management system 1000 and/or system 1001 can process and/or facilitate information flow relating to submission of candidates for potential staffing. As illustrated, step 1511 includes processing and/or facilitating presentations to business development managers. Step 1512 includes process for lockdown of at least one candidate (e.g., confirming candidate interest and/or availability for a particular job requisition). Step 1513 includes processing and/or facilitating resume formatting for the specific candidate to be submitted to a client for consideration. Step 1514 includes actual submission of the candidate to the client (e.g., by providing the client with the candidates name and one or more data or information associated with the candidate, such as the resume formatted at step 1513). Step 1515 includes following up, with the client, regarding the submission of the candidate to determine if the client desires additional information and/or is ready to accept or reject the candidate as a fill for their staffing request.

FIG. 10 depicts a process phase 1560 (e.g., the same or similar to the seventh process phase 1600 of FIG. 6A), the resource acquisition and management system 1000 and/or system 1001 can process and/or facilitate information flow relating to interviewing of candidates for potential staffing. As illustrated, step 1561 includes the gathering of interview details, for example, copies of candidate work and/or education history and/or other data or information that may be of use during interview of a particular candidate. Step 1562 includes confirming with the client that an interview with a particular candidate is desired. If so, step 1563 includes preparing the candidate for interview, including providing the candidate with details and/or information that may be of use during the interview with the client.

Step 1564 includes scheduling a time, date, and/or place for the candidate to meet with the client and/or confirming the schedule with the client and/or the candidate. Step 1565 includes escorting the candidate to an in-person interview with the client or otherwise making accommodations for the client and/or the candidate in support of the interview. Step 1566 involves debriefing the candidate regarding their interview with the client. Likewise, step 1567 involves debriefing with the client regarding their interview with the candidate. Step 1568 includes confirming with the client that they wish to proceed further with the potential staffing of the candidate interviewed. If so, step 1569 includes checking the candidate references to determine any negative marks for which the client and/or the candidate may be made aware.

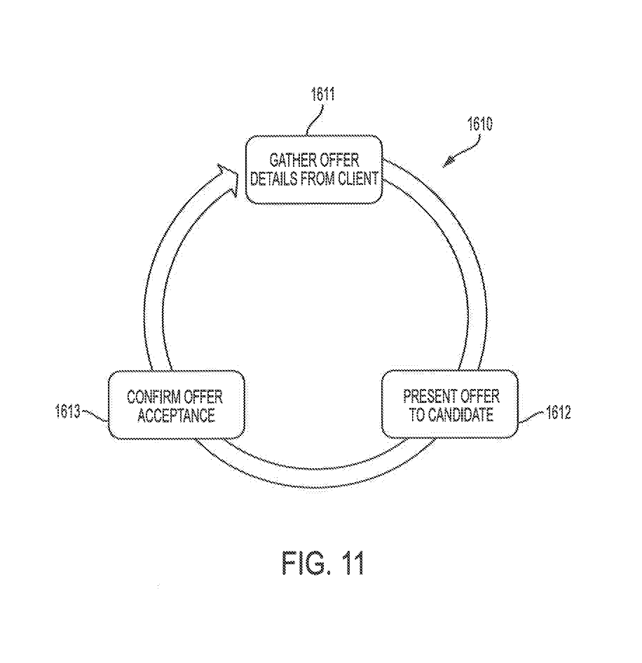

FIG. 11 depicts a process phase 1610 (e.g., the same or similar to the eighth process phase 1600 of FIG. 6A), the resource acquisition and management system 1000 and/or system 1001 can process and/or facilitate information flow relating to offering of candidates staffing positions. As illustrated, step 1611 includes gathering offer details from client (e.g., starting date of employment, time period for employment, salary, benefits, etc.). Step 1612 includes presenting the offer and offer details to the corresponding candidate. Step 1613 includes confirming acceptance of the offer by the candidate (or rejection of the offer). Although specific steps with corresponding to various specific phases have been described for FIGS. 6A-11, alternative embodiments may utilize different numbers of phases utilizing different, additional, and/or fewer steps and/or objectives.

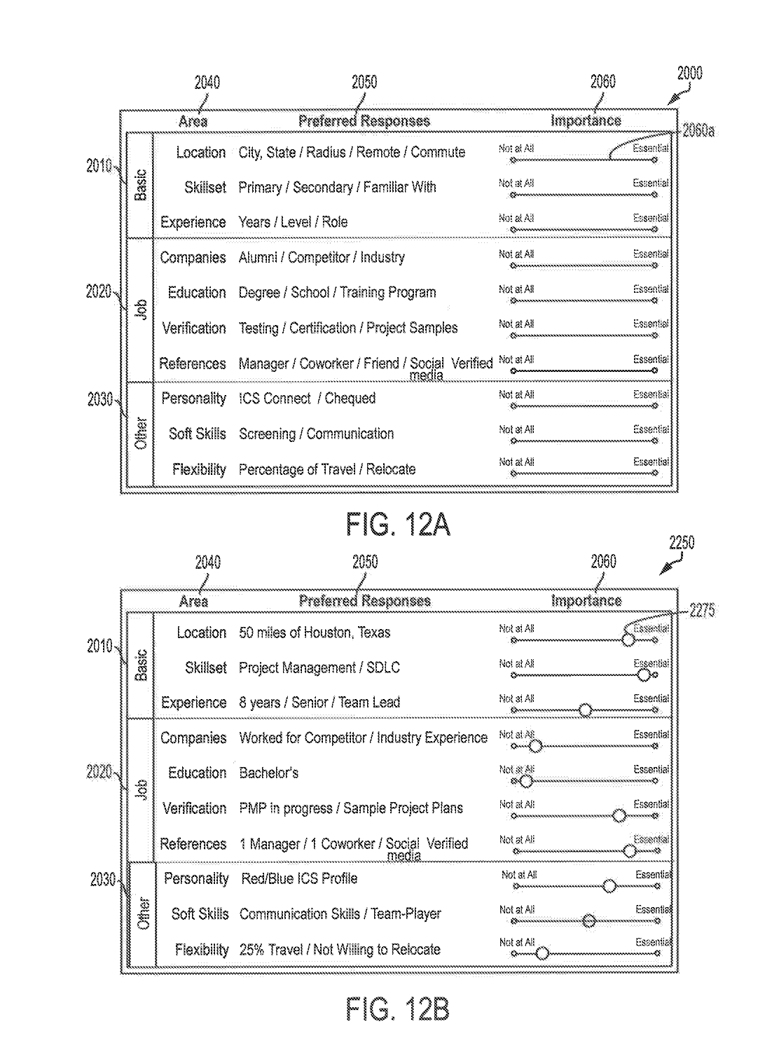

In some embodiments of the invention, the resource acquisition and management system 1000 and/or system 1001 can process at least one online portal comprising a user selectable dashboard related to preferences for any resource requirement form at least one client 600. In some embodiments, the resource acquisition and management system 1000 and/or system 1001 can process preferences from a user 40 using any portion of online portal. For example, FIG. 12A illustrates an exemplary candidate and position preference selection dashboard 2000.

As illustrated, in some embodiments, the selection dashboard 2000 can include a series of preferences comprising basic preferences 2010, and/or job preferences 2020, and/or other preferences 2030. Any of a variety of information or data may be contained within one or more of these preferences. The preferences 2010, 2020, 2030 may be categorized by preference area category 2040, and/or preferred responses category 2050, and/or importance category 2060. Alternative embodiments may use different and/or additional and/or fewer preferences and/or categories. Moreover, the preferences 2010, 2020, 2030 under the importance category 2060 can be selected by a user 40 using at least one user interface element 2060a (e.g., a slide bar). In some embodiments, the at least one slide bar can comprise a user selectable range (e.g., from “not at all” to “essential”). In some other embodiments of the invention, the at least one slide bar can comprise a numeric scale (e.g., from zero to ten). In some other embodiments, the at least one slide bar can comprise other visual, graphical, and/or textural scales. Alternative embodiments may use different and/or additional user interface elements rather than the slide bar explicitly illustrated.

FIG. 12B illustrates a representation 2250 of the candidate and position preference dashboard 2000 in accordance with some embodiments of the invention by showing a plurality of previously selected responses 2275 within the “Preferred Responses” category 2050 and “Importance” category 2060 portion of the dashboard 2000. Thus, upon a user 40 interacting with the dashboard 2000 of FIG. 12A, desired selected responses 2275 may indicate specifically the criteria and how importance such criteria is for finding a potential staffing match among a pool of available candidates.

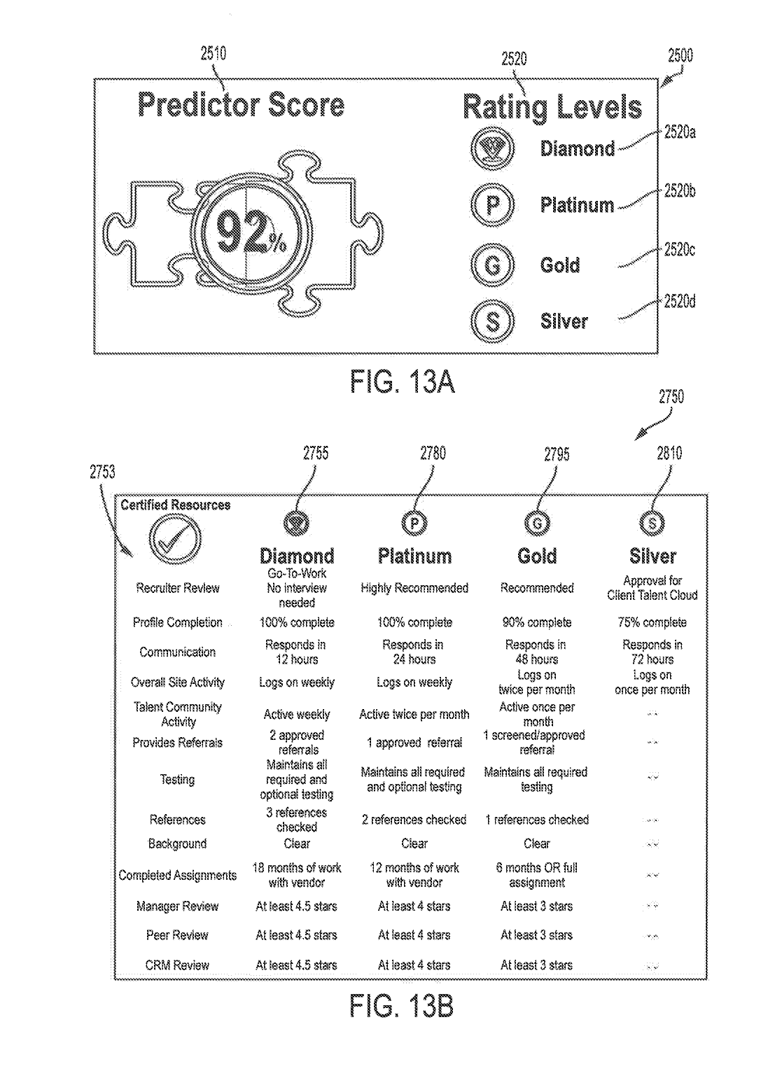

In some embodiments, the resource acquisition and management system 1000 and/or system 1001 can process a predictor and score analysis using a certification process. For example, as previously described for the resource acquisition process 1200 of FIG. 6A and FIG. 7, operation may include completing a job order scorecard (e.g., step 1412). FIG. 13A depicts one exemplary candidate scorecard and/or rating level system 2500. In some embodiments of the invention, using data comprising candidate information as discussed throughout, the resource acquisition and management system 1000 and/or system 1001 can process or determine a predictor score 2510 for any specific candidate (in this example showing a 92% predictor score). This predictor score 2510 may indicate, via percentage, the number of requirements (e.g., those staffing requirements provided by a client) that the particular candidate corresponding to the scorecard matches. In some other embodiments, the predictor score 2510 can comprise a fuzzier percentage (e.g., a range, such as 89-92%).

In some further embodiments of the invention, using data comprising candidate information, the resource acquisition and management system 1000 and/or system 1001 can process or determine rating levels 2520 for a specific candidate. For example, as shown in FIG. 13A, the rating levels 2520 can comprise a plurality of tiers, such as diamond level 2520a, and/or a platinum level 2520b, and/or a gold level 2520c, and/or a silver level 2520d. In some other embodiments of the invention (not shown), the rating levels 2520 can comprise an alphanumeric, and/or a graphical symbol, and/or textural symbol, and/or any combination thereof. Alternative embodiments may use any of a variety of tiers or other indicia for rating levels 2520 and/or may not include any rating levels. Rating levels may, for example, be based upon any of a variety of candidate data (e.g., length of prior employment, work experience, certifications, prior work experience with a specific client, etc.) The algorithms or determinations by the resource acquisition and management system 1000 and/or system 1001 for assigning rating levels 2520 may vary based upon desired implementation preferences.

For example, FIG. 13B illustrates one possible set of determination criteria 2750 for assignment of a particular rating level 2520 to candidates within the resource acquisition and management system 1000 and/or system 1001. As shown, the possible set of determination criteria 2750 can comprise a list certified resources 2753 that have specific values associated with each of the aforementioned rating levels 2520. For example, the determination criteria 2750 can comprise diamond level certifications 2755, and/or platinum level certifications 2780, and/or gold level certifications 2795, and/or silver level certifications 2810. Further as illustrated, the preferences for recruiter review can comprise “go to work, no interview needed” for diamond level certifications 2755, “highly recommended” for platinum level certifications 2780, “recommended” for gold level certifications 2795, and “approval for client talent cloud” for silver level certifications 2810. Further as illustrated, the preferences for profile completion can comprise “100% complete” for diamond level certifications 2755, “100% complete” for platinum level certifications 2780, “90% complete” for gold level certifications 2795, and “75% complete” for silver level certifications 2810.

The preferences for communication can comprise “responds in 12 hours” for diamond level certifications 2755, “responds in 24 hours” for platinum level certifications 2780, “responds in 48 hours” for gold level certifications 2795, and “responds in 72 hours” for silver level certifications 2810. Further as illustrated, the preferences for overall site activity can comprise “logs on weekly” for diamond level certifications 2755, “logs on weekly” for platinum level certifications 2780, “logs on twice per month” for gold level certifications 2795, and “logs on once per month” for silver level certifications 2810. Further as illustrated, the preferences for talent community activity can comprise “active weekly” for diamond level certifications 2755, “active twice per month” for platinum level certifications 2780, and “active once per month” for gold level certifications 2795.

The preferences for provides referrals can comprise “2 approved referrals” for diamond level certifications 2755, “1 approved referral” for platinum level certifications 2780, and “1 screened/approved referral” for gold level certifications 2795. Further as illustrated, the preferences for testing can comprise “maintains all required and optional testing” for diamond level certifications 2755 and for platinum level certifications 2780, and “maintains all required testing” for gold level certifications 2795. Further as illustrated, the preferences for references can comprise “3 references checked” for diamond level certifications 2755, “2 references checked” for platinum level certifications 2780, and “1 reference checked” for gold level certifications 2795.

The preferences for background can comprise “clear” for diamond level certifications 2755, platinum level certifications 2780, and gold level certifications 2795. Further as illustrated, the preferences for completed assignments can comprise “18 months of work with a vendor” for diamond level certifications 2755, “12 months of work with a vendor” for platinum level certifications 2780, and “6 months or a full assignment” for gold level certifications 2795.

The preferences for references can comprise “3 references checked” for diamond level certifications 2755, “2 references checked for platinum level certifications 2780, and “1 reference checked” for gold level certifications 2795. Further as illustrated, the preferences for manager review and/or peer review, and/or “review” can comprise “4.5 stars” for diamond level certifications 2755, “4 stars” for platinum level certifications 2780, and “at least 3 stars” gold level certifications 2795.

Any of a variety of different, additional, and/or fewer resources 2753 and/or corresponding values for the rating levels and/or certifications may be used in alternative embodiments. In some embodiments, a scorecard may allow for a client to conveniently filter candidates by rating level (e.g., indications of a desire to only hire candidates having Platinum rating level or above). Such filtering may encourage candidates within the system to participate actively and/or encourage any of a variety of desired activities associated with higher rating levels. This may aid in retaining a large number of active candidates within the system.

In some embodiments, the resource acquisition and management system 1000 and/or system 1001 can process a candidate profile capable of being viewed by at least one user interfacing with a personal computer and/or other electronic device 40. For example, in some embodiments, the resource acquisition and management system 1000 and/or system 1001 can create and deliver information to one or more clients 600 comprising a candidate profile. In some embodiments, the candidate profile can comprise an online and/or display window comprising text, graphics, and multimedia enable video.

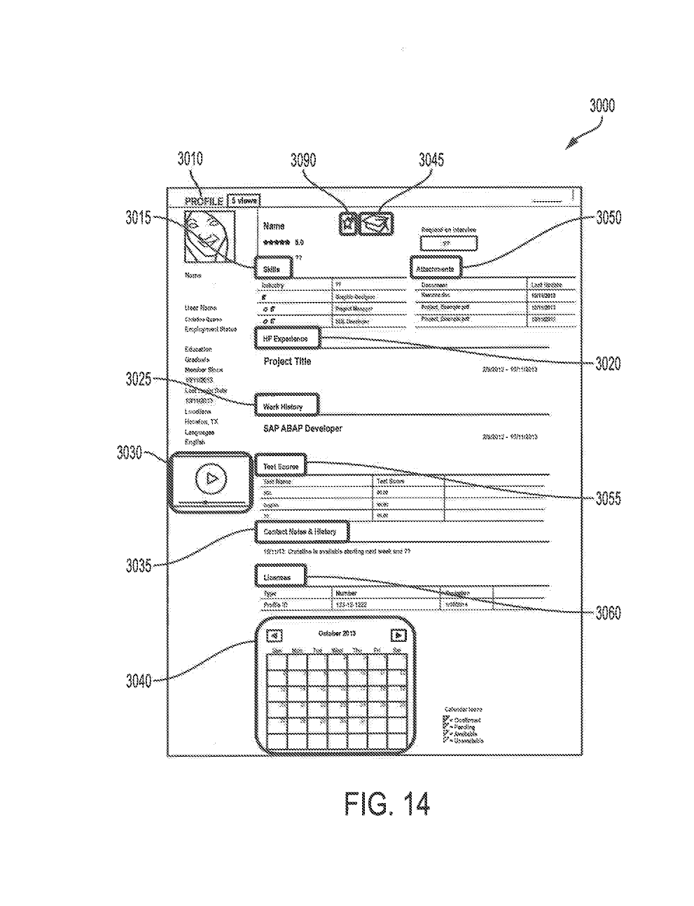

For example, FIG. 14 illustrates a candidate profile board 3000 in accordance with some embodiments of the invention. The candidate profile board 3000 may include various features that are the same as or similar to those discussed throughout. The candidate profile board 3000 can comprise vetted skills 3015, client-specific projects with manager name 3020, and/or other work experience 3025. Further, the candidate profile board 3000 can comprise a link 3030 to view at least one video interview. In addition, the candidate profile board 3000 can comprise notes from history with the candidate 3035 and/or a calendar of availability for new projects 3040.

Moreover, the candidate profile board 3000 can further comprise an alumni indicator 3045 and an attachment link 3050 to enable attachment of a resume, projects, and/or other materials. Further, in some embodiments, the candidate profile board 3000 can include test scores information 3055, and licenses and certifications information 3060. In some embodiments, the candidate profile board 3000 can include an active link 3090 to enable a user 40 to add the candidate to a candidate cloud (such as clouds 200). Thus, clients, vendors, and/or other users may be able to access all or some of the information about one or more candidates via the candidate profile board 3000 in order to more effectively enable staffing decisions.

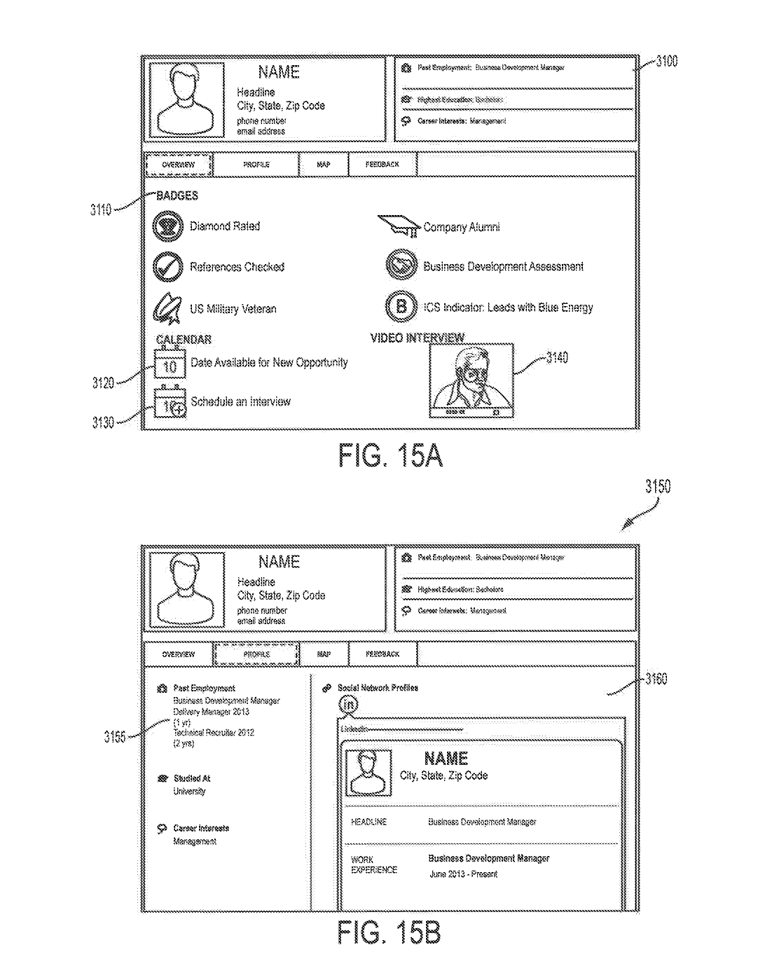

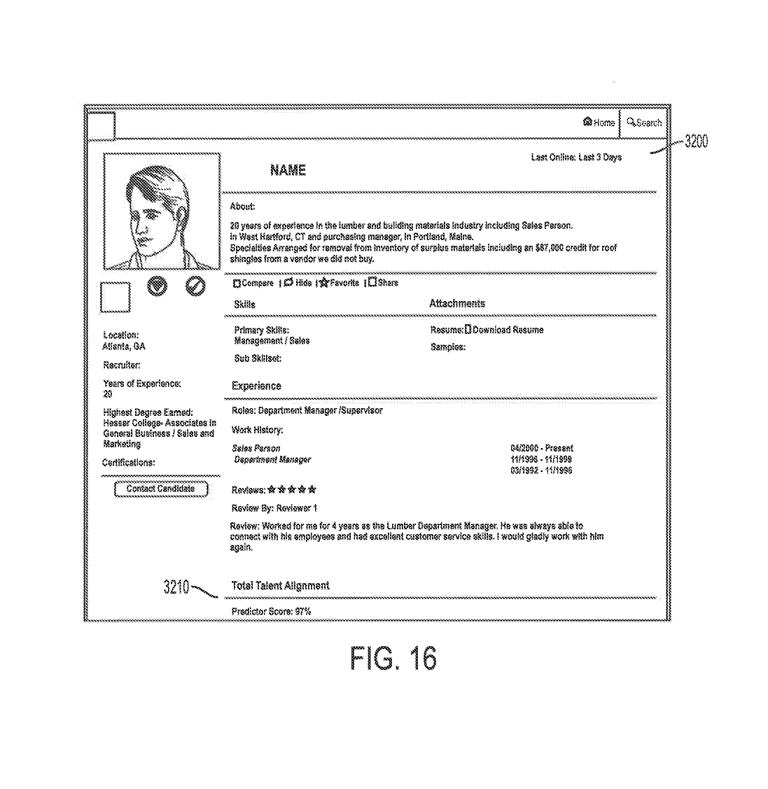

Further examples of electronic profiles capable of being prepared and distributed by the resource acquisition and management system 1000 and/or system 1001 are shown in FIGS. 15A, 15B and 16. For example, FIG. 15A illustrates a candidate profile window 3100, and FIG. 15B illustrates a candidate profile window 3150 in accordance with some embodiments of the invention. FIG. 16 illustrates a candidate profile 3200 in accordance with some embodiments of the invention.

As illustrated in FIG. 15A, the candidate profile window 3100 can comprise a badges display list 3110 that can comprise a rating (e.g., diamond or other rating level as previously discussed), whether references have been checked, whether the candidate is a US military veteran, etc. Any of a variety of different badges or visual notifications may be setup for alternative embodiments. As also show in FIG. 16, the candidate profile 3200 can include a total talent alignment score rating 3210 that can comprise a predictor score (e.g., the same or similar to previous discussions). As discussed previously, in some embodiments, this score can be calculated by the resource acquisition and management system 1000 and/or system 1001 as described earlier with respect to FIGS. 13A (showing a representation that the resource acquisition and management system 1000 and/or system 1001 can process a predictor score 2510).

The badges display list shown in FIG. 15A can also include an indication if the candidate is a company alumni, whether a business development assessment has been performed, whether a personality assessment has been performed, etc. for the candidate. Further, the candidate profile window 3100 can also comprise links to view information regarding a date available calendar 3120 for the candidate, and/or a schedule interview calendar 3130 with the candidate. In some further embodiments, the candidate profile window 3100 can comprise a video interview access window 3140 where a user 40 can view a prior candidate interview. Turning to FIG. 15B, in some embodiments, the candidate profile window 3150 can include a past employment record display 3155, and in some embodiments, a portion of the candidate profile window 3150 can include information to a social network profile window 3160 such as a LinkedIn® profile. LinkedIn, the LinkedIn logo and the IN logo are registered trademarks or trademarks of LinkedIn Corporation.

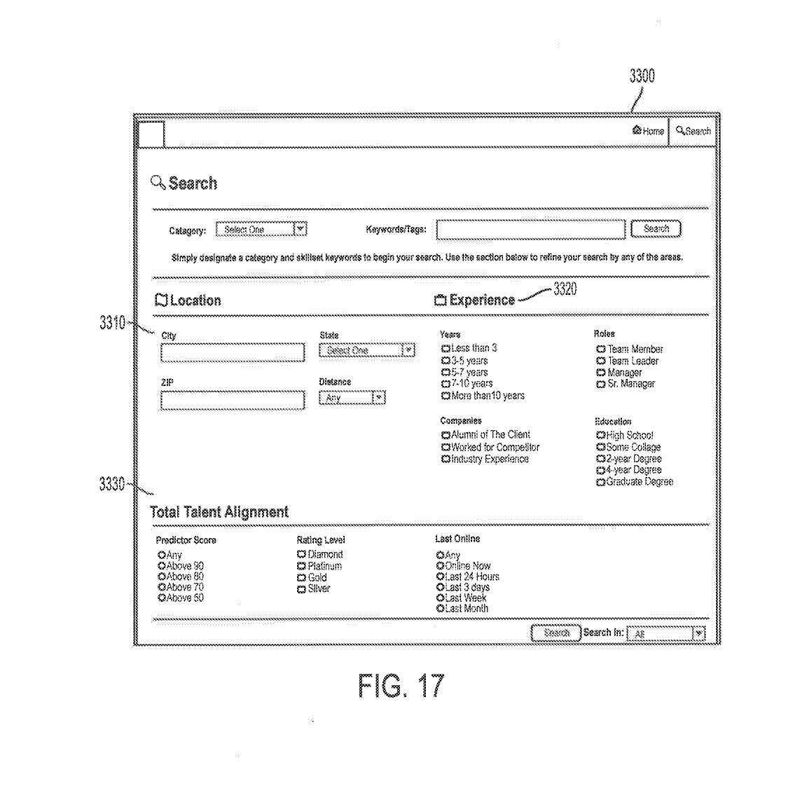

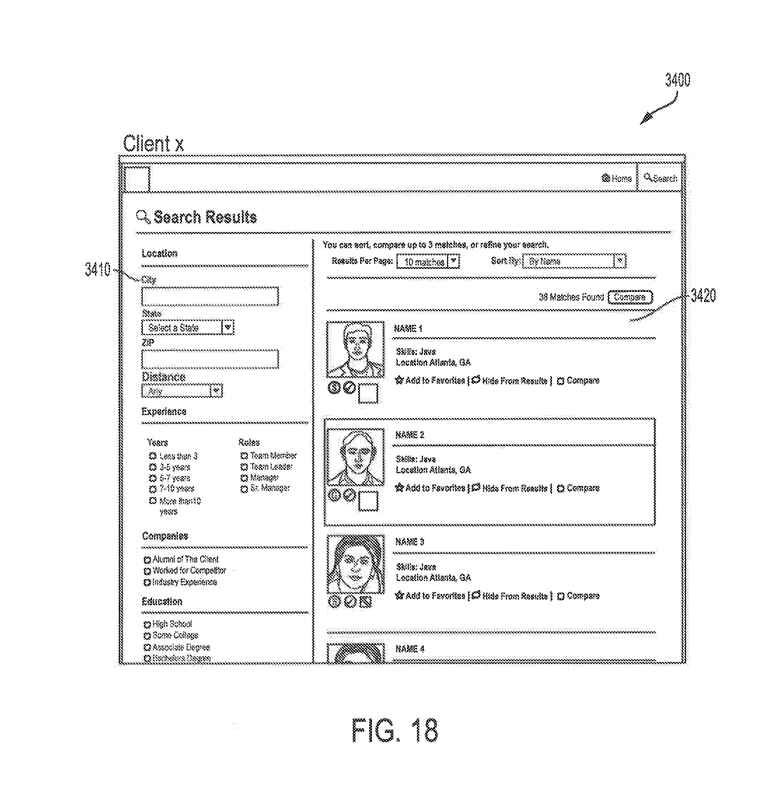

In some embodiments, a user 40 can perform a candidate search using one or more methods of the resource acquisition and management system 1000 and/or system 1001. For example, FIG. 17 illustrates a candidate search window 3300 in accordance with some embodiments of the invention, and FIG. 18 illustrates a candidate search results window 3400 in accordance with some embodiments of the invention. Turning first for FIG. 17, the resource acquisition and management system 1000 and/or system 1001 can enable a user 40 to search for candidates by location 3310, experience 3320, and/or using one or more metrics 3330, wherein the metrics 3330 can comprise a predictor score and/or rating level, and/or based on online activity. Looking at FIG. 18, following a search, the resource acquisition and management system 1000 and/or system 1001 can display a candidate search results window 3400 including a candidate list 3420. In some embodiments, the candidate list 3420 can be further filtered by one or more filter factors 3410 comprising location and/or experience, company employment, and education.

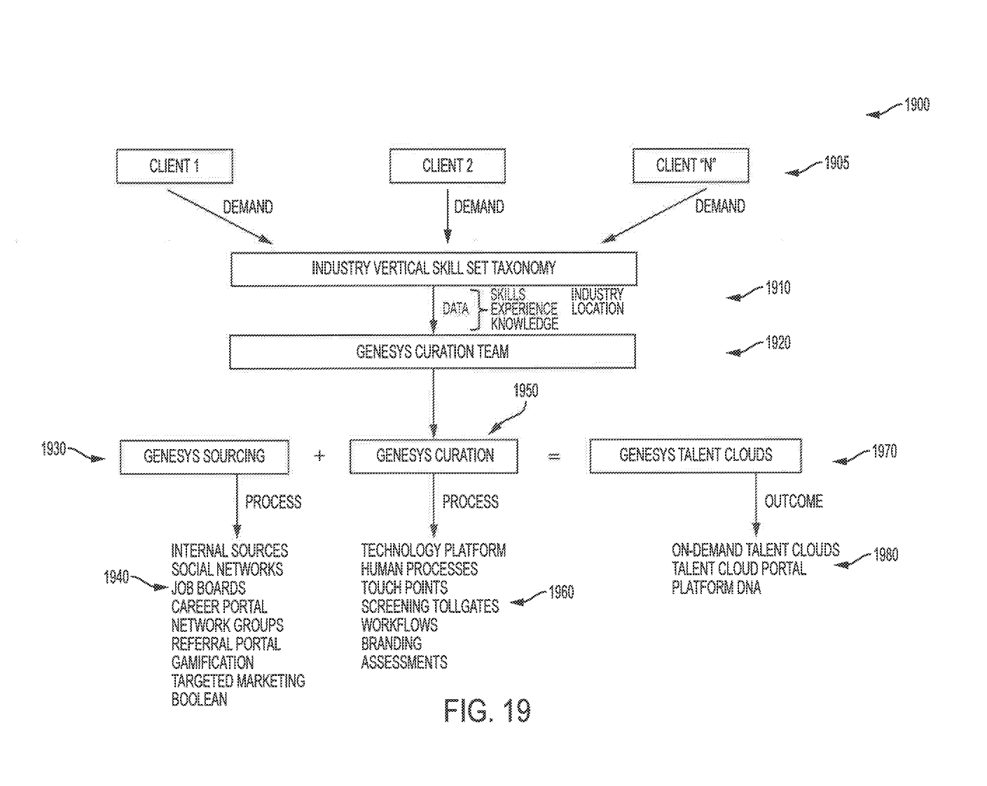

Lastly, FIG. 19 shows a process 1900 for talent cloud curation. For example, the process 1900 may aid in locating available and/or willing candidates that may be used to help fulfill staffing requests. Certain features and/or operation and/or connectivity with a request acquisition and management system may be the same as or similar to those discussed throughout. One or more clients 1905 that interface with a resource acquisition and management system may submit or otherwise communicate requests or demands to the system, indicative of their staffing desires.

Various analysis, classification, ranking, etc. may be performed 1910 based upon data received or indicated as desired by the one or more clients 1905 (e.g., candidate skills, candidate experience, candidate knowledge, industry of candidate, geographic location of candidate, etc.) Various characteristics based upon client desires may be examined or analyzed 1920 in preparation of a search for potential candidates to fulfill the staffing request or desire. A first sourcing process 1930 based upon the characteristics may result from a variety of sourcing locations 1940 that provide candidate information. For example, these may include internal sources (e.g., database of candidates already as part of the system) social networks, job boards, career portals, network groups, gamification, referrals (e.g., from a referral portal, the same or similar as discussed throughout), targeted marketing, Boolean searches, etc.

A second curation process 1950 based upon the characteristics may result from a variety of curation locations 1960 that provide candidate information. For example, these may include technology platforms of the system, human processes, touch points, screening points, workflow, branding, assessments, etc. The combination of these processes (1930, 1950) may result in the creation of a talent cloud 1970 within or for the system that contain a variety of candidate information corresponding to various candidates. The talent cloud 1970 may include, for example, one or more on-demand talent clouds, one or more talent cloud portals, and/or other platform DNA systems or components.

Talent or candidate curation features may be included in a variety of embodiments of the invention. For example, certain embodiments may allow for more efficient or increased mobility of candidates among or between staffing positions. In one embodiment, a candidate that is registered in the system may be permitted to edit and/or cause revisions or modifications to various characteristics that make up their stored candidate information or profile. In such a fashion, candidates may be enabled to take charge of their search for staffing positions, for example, to aid in creation of full-time contracting in the workforce. Candidates may be able to link up with other candidates to hear about potential opportunities, receive or send referrals, link up with one or more clients and/or search for available staffing desires in an effort to reduce the amount of downtime between their contract jobs. These features may be provided as part of a social layer, one or more portals, clouds, or other front-ends meant for candidate interaction, etc. Thus, the system may be focused upon curating participation of candidates to maintain a frequent and active presence within the system wherein they may seek out contract jobs (e.g., rather than staffing placement merely relying upon clients to seek out/recruit potential candidates) to enable more efficient staffing placement.

With the above embodiments in mind, it should be understood that some embodiments of the invention can employ various computer-implemented operations involving data stored in computer systems (such as the system 30 shown in FIG. 5). In addition, in some embodiments, the above-described applications of the monitoring system can be stored on computer-readable storage media. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated. Moreover, although various of the figures have been described with relationship to one or more features, components, and/or methods of other specifically illustrated figures, alternative embodiments may utilize features, components, and/or methods from any of the figures or those alternatives not explicitly illustrated in the exemplary figures contained herein.

For example, a software application (e.g., desktop and/or mobile), dashboard, portal, and/or cloud may be established that is tailored for use by a hiring manager (e.g., of a client) seeking to hire staff for a requisition and/or to monitor currently employed staff that were previously placed through the system. The hiring manager software application, dashboard, portal, and/or cloud may allow the hiring manager to review information or data relating to potential candidates (such as candidate profiles, interviews, resumes, information concerning qualifications, approval of offers to be sent to candidates, interview information and/or feedback, submittal of new requisitions to find staffing, etc.). Indeed, any or all of the various features discussed throughout that may be of interest to a hiring manager or employee of a client seeking staff may be linked to and/or made available via a hiring manager software application, dashboard, portal, and/or cloud in various embodiments.

Likewise, there may be a software application (e.g., desktop and/or mobile), dashboard, portal, and/or cloud that is established that is tailored for use by candidates seeking job placement. This may include search capabilities (e.g., by keyword, industry, state, city, pay level, experience level, certifications required, etc.) that candidates may use in order to seek out open positions that they may be an appropriate fit for. In any or all of the various software applications for various intended users, a social connection or layer may be built into the system that allows communication and/or connections be made between candidates, clients, recruiters, etc. that are involved in the operation of the system for fulfilling staffing requests. The social layer may aid in keeping the various users active within the systems ecosystem and helping prevent candidates or others for creating accounts, but letting the information associated with those accounts languish and become outdated due to a lack of activities that keep users invested and regularly participating in the system. The social layer may also allow for the system to deliver targeted communications to particular candidates based upon their participation in distinct social groups that are organized via the system (e.g., a social group within the social layer for Information Technology subject matter may receive targeted communications from the system to all of its subscribed members relating to staffing opportunities in the IT field, user history/behavior/geography/etc. may enable additional targeted marketing or messages, etc.) Any of a variety of conventional social media features and/or operation may be included as part of the system to help encourage active participants within the system and/or to foster a community of candidates and/or clients.

In addition, there may be a software application (e.g., desktop and/or mobile), dashboard, portal, and/or cloud that is established that is tailored for use for referring individuals to the system and/or referring individuals towards specific requisition fulfillment. Such a referral software application, dashboard, portal, and/or cloud may allow clients and/or candidates to refer clients and/or candidates to the system or towards specific requisition fulfillment. For example, if a first candidate knows of a second candidate would they feel would benefit from use of the system or would be a good fit for a specific requisition with a client, such first candidate may be enabled to submit the second candidate's contact information into the system. The second candidate may then be contacted, either automatically by the system (e.g., via email, text message, phone call, etc.) or by an individual asking if they would like to join and/or consider placement for one or more specific requisitions. Rewards or other benefits (e.g., ranking levels, badges, etc. as previously discussed) may be used to encourage users of the system to participate in referring others. Referral features or operation can include any of a variety of possibilities (e.g., a first candidate referring another candidate, a client referring a particular candidate to a different client, etc.) In such a fashion, an economy for a workforce (e.g., temporary or contract workforce) may be enabled by the system wherein qualified candidates may be shared / referred among competitor clients, reducing downtime in staffing placement.

In certain embodiments, a system utilizing one or more of the features discussed throughout may also incorporate various reporting capabilities and/or data or statistical analysis. For example, reporting features may be available to a client (e.g., at an extra fee) that allows the client to more easily manage their activities upon the system. For example, such reporting features may indicate how many requisitions are currently open, how many have yet to be assigned to a recruiter, how many are on hold, how many are un-reviewed, what the current requisition load looks like for particular individuals associated with the client, recently rejected offers, upcoming due dates, etc. Any of a variety of reporting and/or data or statistical features may be provided and may allow the viewer a convenient and/or quick look at relevant activity associated with their account on the system.

Any of the operations described herein that form part of the invention are useful machine operations. The invention also relates to a device or an apparatus for performing these operations. The embodiments of the invention can be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by one or more processors 32. In such an example, the processors 32 can transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media (such as computer readable medium 36) as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Any of the above features discussed may be utilized or incorporated or combined with or into other staffing system solutions retrofitted onto existing staffing solutions. The previous description of the disclosed examples is provided to enable any person of ordinary skill in the art to make or use the disclosed methods and apparatus. Accordingly, the terminology employed throughout should be read in a non-limiting manner. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and/or methods.

What is claimed is:

1. A system for aiding in fulfilling staffing requests comprising:
a processor;
a memory for tangibly storing thereon computer-readable instructions configured to be executed by the processor, the computer-readable instructions configured to:
receive data from a client corresponding to a staffing requirement,
establish a first link with a vendor for communication of at least some of the data received from the client,
receive a plurality of candidate information corresponding to a plurality of candidates from the vendor for fulfilling the staffing requirement,
analyze the plurality of candidate information from the vendor,
rank at least some of the plurality of candidates based on the analysis of the plurality of candidate information received from the vendor,
establish a second link with the client for communication of at least some of the plurality of candidate information received from the vendor and the rank of at least some of the plurality of candidates, and
receive an approval from the client corresponding to at least one of the plurality of candidates.

2. The system of claim 1 wherein the first link is established directly with the vendor.

3. The system of claim 1 wherein the first link is established through a VMS.

4. The system of claim 1 wherein the second link is established directly with the client.

5. The system of claim 1 wherein the second link is established through an MSP.

6. The system of claim 1 wherein the computer-readable instructions are further configured to establish at least one portal configured to be accessed by the client or a candidate relating to the candidate information.

7. The system of claim 6 wherein the at least one portal is a web-based portal accessible over the Internet.

8. The system of claim 1 wherein the computer-readable instructions are further configured to search the memory for second candidate information for fulfilling the staffing requirement.

9. The system of claim 8 wherein the memory comprises a plurality of storage mediums configured to be accessed by the processor.

10. The system of claim 9 wherein the computer-readable instructions are stored on a first of the plurality of storage mediums and the second candidate information is stored on a second of the plurality of storage mediums.

11. The system of claim 8 wherein the second candidate information comprises information corresponding to a candidate in at least one of the following groups: (i) alumni of the client or (ii) current temporary employee of the client.

12. A method for aiding in fulfilling staffing requests comprising:
receiving data from a client corresponding to a staffing requirement;
establishing a first link with a vendor for communication of at least some of the data received from the client;
receiving a plurality of candidate information corresponding to a plurality of candidates from the vendor for fulfilling the staffing requirement;
analyzing the plurality of candidate information from the vendor;
ranking at least some of the plurality of candidates based on the analysis of the plurality of candidate information received from the vendor;
establish a second link with the client for communication of at least some of the plurality of candidate information received from the vendor and the rank of at least some of the plurality of candidates; and
receiving an approval from the client corresponding to at least one of the plurality of candidates.

13. The system of claim 12 wherein the second link is established through an MSP.

14. The system of claim 13 wherein the first link is established through a VMS.

15. A system for aiding in fulfilling staffing requests comprising:
a processor;
a memory for tangibly storing thereon computer-readable instructions configured to be executed by the processor, the computer-readable instructions configured to:
receive data from a client corresponding to a staffing desire,
establish a first link with a vendor for communication of at least some of the data received from the client,
determine a plurality of candidate information corresponding to a plurality of candidates for fulfilling the staffing desire wherein at least some of the plurality of candidate information is determined via a plurality of candidate profiles editable by their corresponding plurality of candidates,
rank at least some of the plurality of candidates based on at least some of the plurality of candidate information, and
establish a second link with the client for communication of at least some of the plurality of candidate information received from the vendor and the rank of at least some of the plurality of candidates.

16. The system of claim 15 wherein the determination of a plurality of candidate information results from a search of one or more of the following: (i) social networks, (ii) job boards, or (iii) referrals.

17. The system of claim 15 wherein the plurality of candidate profiles indicate a rating level for each of the corresponding plurality of candidates.

18. The system of claim 17 wherein the rating level is based on a particular candidate's frequency of login with the system.

19. The system of claim 15 wherein the computer-readable instructions are further configured to establish a referral portal for referring one or more candidates to fulfill the staffing desire.

20. The system of claim 19 wherein the referral portal is configured to be accessed by the client for referral of a candidate to a staffing desire of a different client.
